(19) United States
(12) Patent Application Publication
(10) Pub. No.: US 2015/0089558 A1
(43) Pub. Date: Mar. 26, 2015

(54) CONTENT DATA RECORDING DEVICE, CONTENT DATA RECORDING METHOD, RECORDING MEDIUM, AND CONTENT DELIVERING SYSTEM

(71) Applicant: Sharp Kabushiki Kaisha, Osaka-shi, Osaka (JP)

(72) Inventor: Toshinori Shimizu, Osaka-shi (JP)

(73) Assignee: Sharp Kabushiki Kaisha, Osaka-shi, Osaka (JP)

(21) Appl. No.: 14/388,637

(22) PCT Filed: Nov. 13, 2012
(86) PCT No.: PCT/JP2012/079400

§ 371 Date: Sep. 26, 2014

(30) Foreign Application Priority Data
Mar. 30, 2012 (JP) 2012-081954

(51) Int. Cl. H04N 21/433; H04N 21/442; H04N 21/2343; H04N 21/2662; H04N 21/24; H04N 21/414; H04N 5/919

(52) U.S. Cl. CPC H04N 21/4334; H04N 21/41407; H04N 21/44209; H04N 5/919; H04N 21/2662; H04N 21/2402; H04N 21/234345
USPC 725/96

(57) ABSTRACT

A content data recording device of the present invention includes: a first obtaining section which obtains content data used to reproduce a content by streaming and which switches, depending on a communication state, between obtainment of high-quality data and obtainment of low-quality data; a second obtaining section which obtains, part of the high-quality data which part has not been obtained by the first obtaining section, after the communication state is recovered; and a recording performing section (404) which records (i) the high-quality data obtained by the first obtaining section and (ii) the part of the high-quality data obtained by the second obtaining section.

### TECHNICAL FIELD

The present invention relates to a content data recording device and a content data recording method, each of which is for recording externally obtained content data.

### BACKGROUND ART

In accordance with the prevalence of the Internet or the increase in performance of computers, delivery of large-volume contents, such as moving images, has been widely made via the Internet. For example, there is a service called VOD (Video On Demand), through which a content such as a moving image is delivered in response to a request from a user. According to the VOD, data is transmitted and received between a server (a content providing device) and a client (a content reproducing device) over HTTP (HyperText Transfer Protocol) as described in, for example, Patent Literature 1.

Here, various techniques have been developed for delivery of a content over HTTP. For example, there is known a technique of reproducing a given content by streaming while switching a plurality of bandwidths (bit rates), with each of which the content is obtained, depending on a communication environment with the use of an SMIL file which adapts the given content to the plurality of bandwidths. Further, Patent Literature 1 discloses a technique of time-dividing a given content into a plurality of segments and then delivering the content on a segment basis.

In recent years, performances of mobile terminals, serving as clients, have been increased, and mobile terminals have been developed which have wireless communication means and which reproduce, through a VOD service, a content by streaming. A wireless communication means changes in its communication state depending on an environment where a mobile terminal is present. Therefore, according to such mobile terminals, there has been a problem that, in a case where the communication state of the wireless communication means becomes poor, it is not possible to reproduce a content.

In order to solve this problem, there is known a content providing device that has (i) data for a high bit rate which data can be watched (transmitted and received) in a case where a communication state is in normal and (ii) data for a low bit rate which data can be watched even in a case where the communication state is poor and that switches, between the data for a high bit rate and the data for a low bit rate, data which a content reproducing device is to obtain, depending on the communication state. Streaming in which data for a high bit rate and data for a low bit rate is thus switched depending on a communication state is referred to as adaptive streaming.

### CITATION LIST

### Patent Literature

Patent Literature 1
Japanese Patent Application Publication, Tokukai, No. 2005-110244 A (Publication Date: Apr. 21, 2005)

### Non Patent Literature

Non Patent Literature 1
“Information technology-MPEG systems technologies—Part6: Dynamic Adaptive streaming over HTTP(DASH)”, [online], Jan. 28, 2011, ISO/IEC, [search on Mar. 19, 2012], the Internet <URL: http://www.itscj.ipsj.or.jp/sc29/open/29view/29n11873t.doc>

### SUMMARY OF INVENTION

### Technical Problem

However, according to such a technique that data for a high bit rate and data for a low bit rate are switched, in a case where a communication state is poor, a content reproducing device obtains the data for a low bit rate. Therefore, there is a problem that, in a case where a content is recorded while being watched, the content is recorded with a low quality. In other words, according to the conventional technique, there is a problem that, in a case where a content reproduced by streaming is recorded while the content is being watched, all or part of the content has a low quality.

Further, in general, a method of reproducing a content by streaming has been employed so that the content does not remain on a client side. Therefore, it is not conventionally assumed that a content is recorded while being reproduced by streaming. Therefore, the forgoing problem has not conventionally arisen.

The present invention has been made in view of the above problem, and an object of the present invention is to provide (i) a content data recording device and a content data recording method, each of which is capable of recording a content with a high-quality while reproducing the content.

### Solution to Problem

In order to attain the above object, a content data recording device in accordance with the present invention is a content data recording device which records content data externally obtained, including: a first obtaining means for (i) obtaining content data used to reproduce a content by streaming and (ii) switching, depending on a communication state, between obtainment of high-quality content data and obtainment of low-quality content data; a second obtaining means for obtaining part of the high-quality content data which part has not been obtained by the first obtaining means, after the communication state is recovered; and a recording means for recording (i) the high-quality content data obtained by the first obtaining means and (ii) the part of the high-quality content data obtained by the second obtaining means.

Further, a method of recording content data in accordance with the present invention is a method of recording content data externally obtained, including the steps of: (a) obtaining content data used to reproduce a content by streaming, and switching, depending on a communication state, between obtainment of high-quality content data and obtainment of low-quality content data; (b) obtaining part of the high-quality content data which part has not been obtained in the step (a), after the communication state is recovered; and (c) recording (i) the high-quality content data obtained in the step (a) and (ii) the part of the high-quality content data obtained in the step (b).

According to the above configuration, the recording means records (i) the high-quality content data, used to reproduce the content by streaming, which the first obtaining means has obtained as a result of switching between the obtainment of the high-quality content data and the obtainment of the low-quality content data depending on the communication state and (ii) the part of the high-quality content data which part the first obtaining means has not obtained because the first obtaining means has obtained the low-quality content data and which part the second obtaining means has obtained after the communication state is recovered. Therefore, it is possible to record all of the content data with the use of the high-quality content data while reproducing the content by streaming.

### Advantageous Effects of Invention

As described above, a content data recording device in accordance with the present invention includes: a first obtaining means for (i) obtaining content data used to reproduce a content by streaming and (ii) switching, depending on a communication state, between obtainment of high-quality content data and obtainment of low-quality content data; a second obtaining means for obtaining part of the high-quality content data which part has not been obtained by the first obtaining means, after the communication state is recovered; and a recording means for recording (i) the high-quality content data obtained by the first obtaining means and (ii) the part of the high-quality content data obtained by the second obtaining means.

Further, a method of recording content data in accordance with the present invention includes the steps of: (a) obtaining content data used to reproduce a content by streaming, and switching, depending on a communication state, between obtainment of high-quality content data and obtainment of low-quality content data; (b) obtaining part of the high-quality content data which part has not been obtained in the step (a), after the communication state is recovered; and (c) recording (i) the high-quality content data obtained in the step (a) and (ii) the part of the high-quality content data obtained in the step (b).

It is therefore possible to record all content data as high-quality content data while reproducing a content of the content data by streaming.

For a fuller understanding of the nature and advantages of the invention, reference should be made to the ensuing detailed description taken in conjunction with the accompanying drawings.

### BRIEF DESCRIPTION OF DRAWINGS

FIG. 1 illustrates a detailed example of a reproduction control metafile of a content to be delivered over HTTP.

FIG. 2 illustrates a basic example description of ERI contained in a reproduction control metafile.

FIG. 3 illustrates an example description of ERI contained in a reproduction control metafile of a content having high-quality data and low-quality data.

FIG. 4 illustrates an example description of ERI contained in a reproduction control metafile of a time-divided content.

FIG. 5 illustrates an example description of ERI contained in a reproduction control metafile of a content having high-quality data and low-quality data each of which is time-divided into six segments.

FIG. 6 is a view illustrating an example configuration of a content delivering system in accordance with the present invention.

FIG. 7 is a block diagram illustrating an example configuration of a main part of a tuner which is included in a content delivering system and which supplies data in TS format to a monitor.

FIG. 8 is a block diagram illustrating an example configuration of a main part of a tuner which is included in a content delivering system and which supplies data in HDMI format to a monitor.

FIG. 9 is block diagram illustrating an example configuration of a main part of a control section of a tuner.

FIG. 10 is a block diagram illustrating an example configuration of a main part of a monitor which is included in a content delivering system and which receives data in TS format.

FIG. 11 is a block diagram illustrating an example configuration of a main part of a monitor which is included in a content delivering system and which receives data in TS format and data in HDMI format.

FIG. 12 is a block diagram illustrating an example configuration of a main part of a control section of a monitor.

FIG. 13 is a view illustrating an example of a reproduction and recording process carried out by a monitor.

FIG. 14 is a view illustrating an example configuration of a content delivering system in a specific example of the reproduction and recording process carried out by a monitor.

FIG. 15 is a view illustrating an example configuration of a content delivering system in a specific example of the reproduction and recording process carried out by a monitor.

FIG. 16 is a view illustrating an example configuration of a content delivering system in a specific example of the reproduction and recording process carried out by a monitor.

FIG. 17 is a view illustrating, with respect to a time axis of reproduction of a content, (i) a wireless communication state between a content reproducing device and a content delivering device, (ii) content data reproduced by the content reproducing device, and (iii) the content data recorded by the content reproducing device, in the example.

FIG. 18 is a view illustrating, with respect to a time axis of reproduction of a content, (i) a wireless communication state between a content reproducing device and a content delivering device, (ii) content data reproduced by the content reproducing device, and (iii) the content data recorded by the content reproducing device, in the example.

FIG. 19 is a view illustrating, with respect to a time axis of reproduction of a content, (i) a wireless communication state between a content reproducing device and a content delivering device, (ii) content data reproduced by the content reproducing device, and (iii) the content data recorded by the content reproducing device, in the example.

FIG. 20 is a view illustrating an example of a reproduction process carried out by a monitor in a case where a tuner carries out a transfer recording process.

FIG. 21 is a view illustrating an example of a transfer recording process carried out by a tuner.

FIG. 22 is a view illustrating an example configuration of a content delivering system in a specific example of a reproduction and recording process carried out by a tuner.

FIG. 23 is a view illustrating an example configuration of a content delivering system in a specific example of the reproduction and recording process carried out by a tuner.

FIG. 24 is a view illustrating an example configuration of a content delivering system in a specific example of the reproduction and recording process carried out by a tuner.

FIG. 25 is a view illustrating, with respect to a time axis of reproduction of a content, (i) a wireless communication state between a content reproducing device and a content delivering device, (ii) content data reproduced by the content reproducing device, and (iii) the content data recorded by the tuner, in the example.

FIG. 26 is a view illustrating, with respect to a time axis of reproduction of a content, (i) a wireless communication state between a content reproducing device and a content delivering device, (ii) content data reproduced by the content reproducing device, and (iii) the content data recorded by the tuner, in the example.

### DESCRIPTION OF EMBODIMENTS

### Content to be Delivered by Content Delivering Device

Each content to be delivered by a content delivering device is associated with a corresponding reproduction control metafile. The reproduction control metafile is information used in a case where a content reproducing device obtains and reproduces a content by use of a VOD streaming technique.

Before reproducing a content, the content reproducing device first obtains, from the content delivering device, a reproduction control metafile associated with the content to be reproduced. The content reproducing device then obtains and reproduces the content in accordance with the reproduction control metafile thus obtained.

For example, a reproduction control metafile contains (i) where to obtain data, of a given content, for a high bit rate and (ii) where to obtain data, of the given content, for a low bit rate. The content reproducing device obtains, in accordance with the reproduction control metafile, (i) the data, of the given content, for a high bit rate or (ii) the data, of the given content, for a low bit rate, depending on a communication state. By thus using a reproduction control metafile, adaptive streaming is realized.

Note that a content associated with a reproduction control metafile is hereinafter referred to as a target content. Note also that data for a high bit rate is hereinafter referred to as high-quality data (high-quality content data) and data for a low bit rate is hereinafter referred to as low-quality data (low-quality content data). The adaptive streaming also includes dynamically changing a bit rate of a content to be delivered, depending on not only a communication state of a transmission path but also processing ability and/or a screen size of the content reproducing device.

[Reproduction Control Metafile]

Specifically, a reproduction control metafile contains three XML documents, i.e., ERI (Entry Resource Information), LLI (License Line Information), and NCI (Network content Control Information). That is, the reproduction control metafile contains, for example, information used to control obtainment and reproduction of a content or information on DRM (Digital Rights Management).

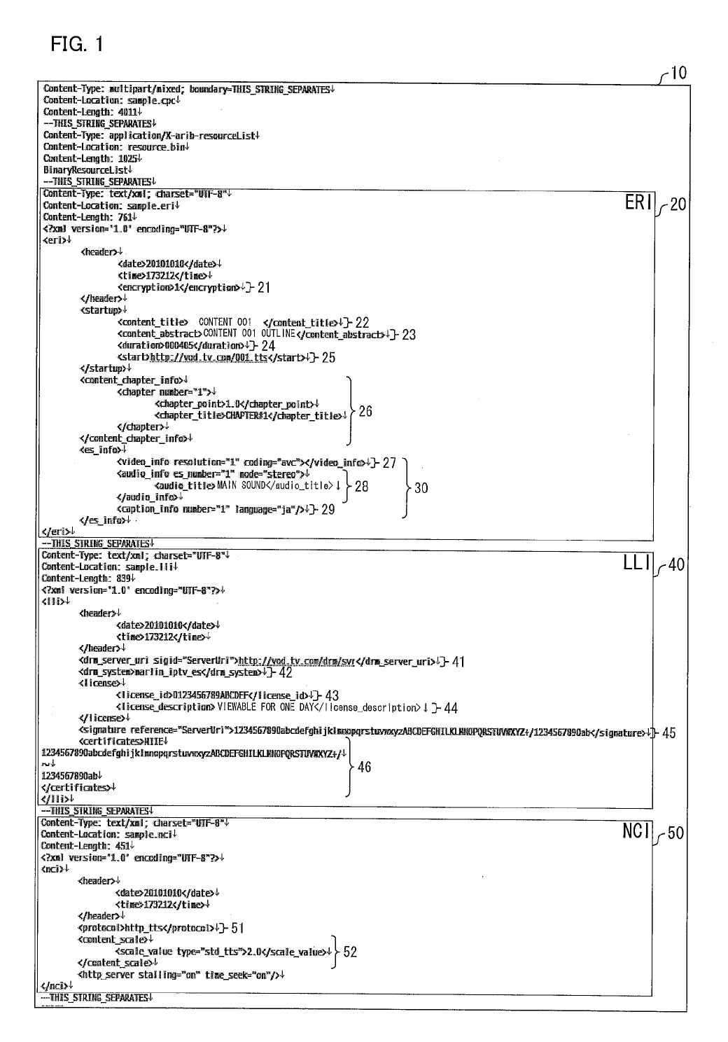

The ERI, the LLI, and the NCI are each formulated by Networked Digital Television study group and IPTV forum Japan. FIG. 1 illustrates a detailed example of a reproduction control metafile of a content to be delivered over HTTP. With reference to FIG. 1, the ERI, the LLI, and the NCI will be described below in detail.

FIG. 1 is a view illustrating an example of a reproduction control metafile. As illustrated in FIG. 1, a reproduction control metafile 10 contains ERI 20, LLI 40, and MCI 50.

The ERI 20 includes: identification information 21 indicative of whether or not a target content is an encrypted content; title information 22 indicative of a title of the target content; outline information 23 indicative of an outline of the target content; time length information 24 indicative of a time length of the target content; information (entry information) 25 indicative of where to refer to actual data of the target data; chapter information 26 based on which the content reproducing device reproduces the target content on a chapter basis; attribute information 27 on a video signal; attribute information 28 on an audio signal; and attribute information 29 on a caption signal (see FIG. 1). The attribute information 27 on the video signal, the attribute information 28 on the audio signal, and the attribute information 29 on the caption signal are collectively referred to as attribute information 30. The content reproducing device displays the title, the outline, the time length of the target content in accordance with the title information 22, the outline information 23, and the time length information 24.

The LLI 40 includes: a URI 41 of a DRM server; identification information 42 on a DRM system; a license ID 43; use condition text information 44 on a license; a signature 45; and a public key certificate 46 for verification of the signature (see FIG. 1). The LLI 40 thus includes information necessary for obtaining the license of the target content and use condition information on the license of the target content. This causes the LLI 40 to securely guide the content reproducing device to a server from which the content reproducing device can properly obtain a license.

The NCI 50 includes: identification information 51 on a streaming protocol; and information 52 indicative of a system and a multiple speed of variable speed reproduction which are available (see FIG. 1). The NCI 50 can further include identification information on an FEC system and a parameter. The NCI 50 indicates various parameters particularly necessary for HTTP streaming.

[ERI]

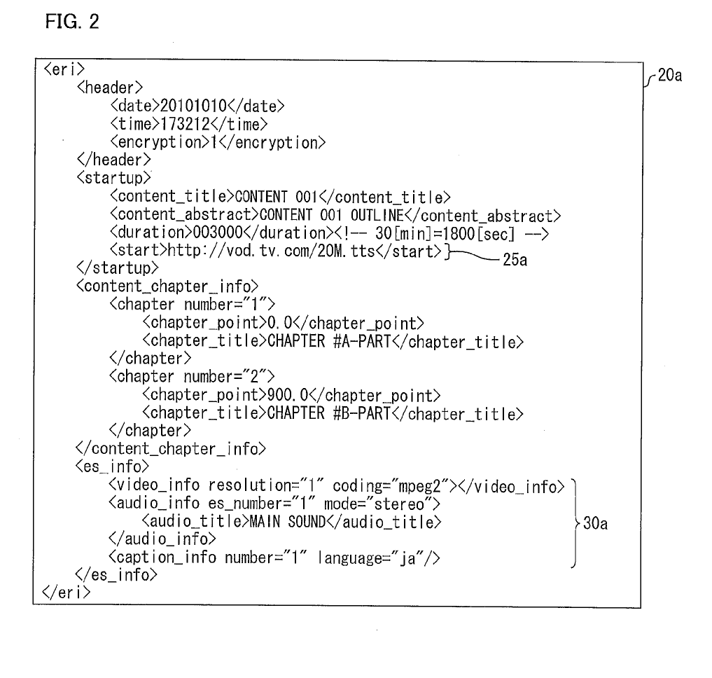

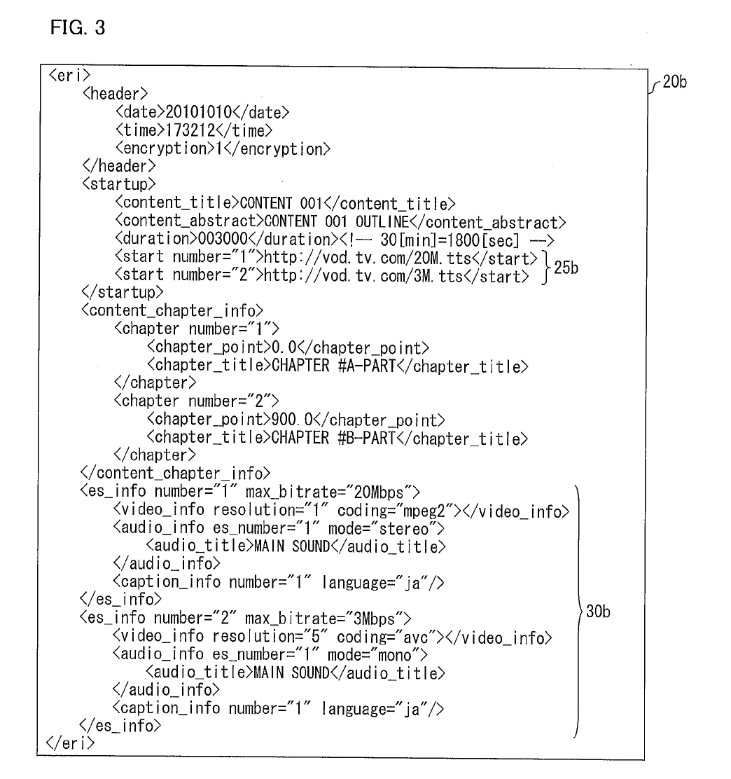

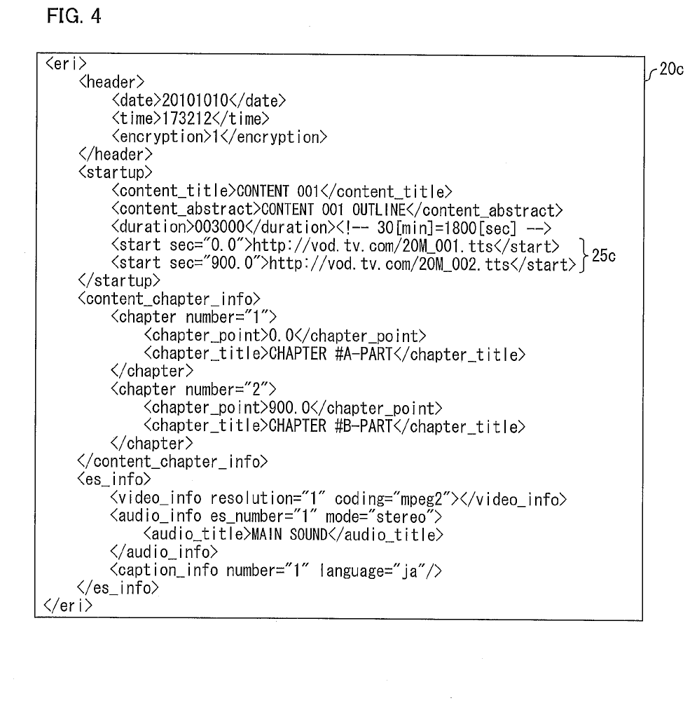

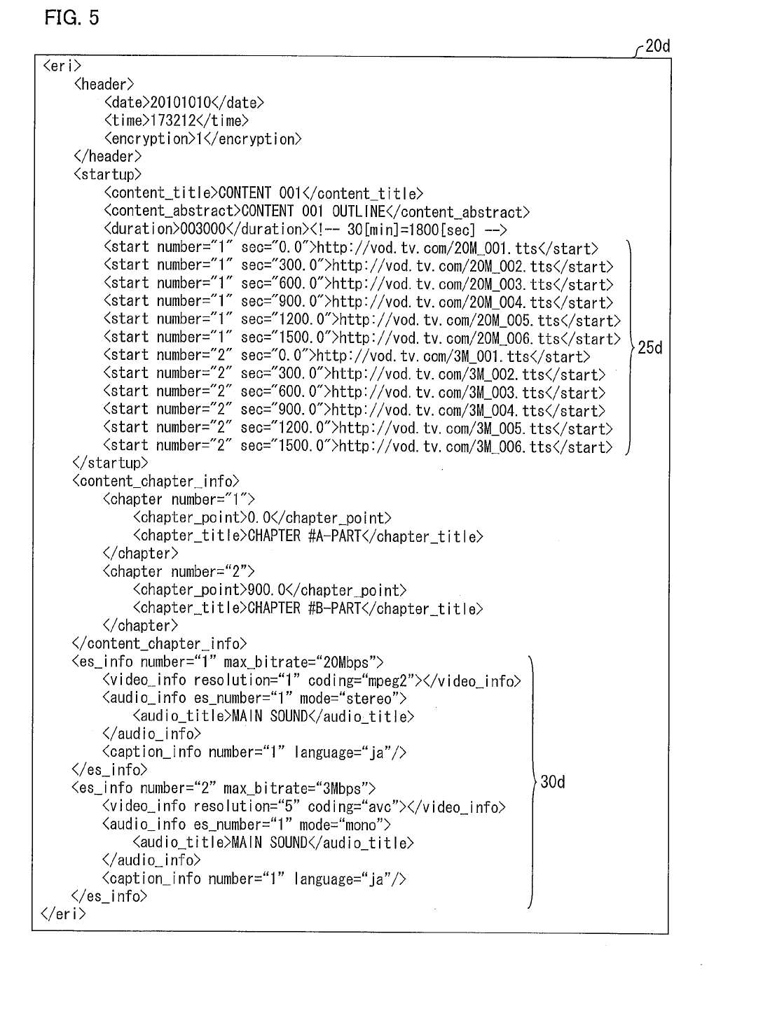

Next, various example descriptions of the ERI will be described below with reference to FIGS. 2 through 5. FIG. 2 illustrates a basic example description of ERI. FIG. 3 illustrates an example description of ERI of a content having high-quality data and low-quality data. FIG. 4 illustrates an example description of ERI of a time-divided content. FIG. 5 illustrates an example description of ERI of a content having high-quality data and low-quality data each of which is time-divided.

According to an example illustrated in FIG. 2, a content which is delivered at 20 Mbps is stored in the content delivering device, and where to obtain the content is described in entry information 25a of ERI 20a. Meanwhile, attribute information of the content delivered at 20 Mbps is described in attribute information 30a.

According to an example illustrated in FIG. 3, (i) data of a content delivered at 20 Mbps which data is high-quality data and (ii) data of the content delivered at 3 Mbps which data is low-quality data are stored in the content delivering device. Where to obtain (i) the data of the content delivered at 20 Mbps and (ii) the data of the content delivered at 3 Mbps are each described in entry information 25b of ERI 20b.

Meanwhile, (i) attribute information on the content delivered at 20 Mbps and (ii) attribute information on the content delivered at 3 Mbps are described in attribute information 30b. As illustrated in FIG. 3, “es_info number=“1” in the attribute information 30b corresponds to “start number=“1”” in the entry information 25b, and “es_info number=“2”” in the attribute information 30b corresponds to “start number=“2”” in the entry information 25b. That is, attribute information described in the tag “es_info number=“1”” is the attribute information on the content delivered at 20 Mbps, whereas attribute information described in the tag “es_info number=“2”” is the attribute information of the content delivered at 3 Mbps. The content reproducing device displays a bite rate of the content in accordance with “max_bitrate=“20 Mbps”” or “max_bitrate=“3 Mbps”.”

According to an example illustrated in FIG. 4, a time-divided content is stored in the content delivering device. Specifically, a 30-minute content is divided into (i) a first segment from 0 (zero) minute to 15 minutes and (ii) a second segment from 15 minutes to 30 minutes. Where to obtain the first segment and the second segment are each described in entry information 25c of ERI 20c (see FIG. 4).

According to FIG. 5, (i) data of a content delivered at 20 Mbps which data is high-quality data and (ii) data of the content delivered at 3 Mbps which data is low-quality data are stored in the content delivering device in a state where each of the data of the content delivered at 20 Mbps and the data of the content delivered at 3 Mbps is time-divided into six segments. Specifically, the high-quality data of 30 minutes is divided into (i) a high-quality first segment from 0 (zero) minute to 5 minutes, (ii) a high-quality second segment from 5 minutes to 10 minutes, (iii) a high-quality third segment from 10 minutes to 15 minutes, (iv) a high-quality fourth segment from 15 minutes to 20 minutes, (v) a high-quality fifth segment from 20 minutes to 25 minutes, (vi) a high quality sixth segment from 25 minutes to 30 minutes. Similarly, the low-quality data of 30 minutes is divided into (i) a low-quality first segment from 0 (zero) minute to 5 minutes, (ii) a low-quality second segment from 5 minutes to 10 minutes, (iii) a low-quality third segment from 10 minutes to 15 minutes, (iv) a low-quality fourth segment from 15 minutes to 20 minutes, (v) a low-quality fifth segment from 20 minutes to 25 minutes, (vi) a low quality sixth segment from 25 minutes to 30 minutes.

In entry information 25d of ERI 25d, where to obtain the high-quality first segment, the high-quality second segment, the high-quality third segment, the high-quality fourth segment, the high-quality fifth segment, the high-quality sixth segment, the low-quality first segment, the low-quality second segment, the low-quality third segment, the low-quality fourth segment, the low-quality fifth segment, and the low-quality sixth segment are each described (see FIG. 5).

Similar to the ERI 20b illustrated in FIG. 3, (i) attribute information on the high-quality data and (ii) attribute information on the low-quality data are described in attribute information 30d.

[DASH]

DASH (Dynamic Adaptive Streaming over HTTP) is a standard specification of an HTTP adaptive streaming technique (HAS) which is being formulated by MPEG.

According to DASH, a content is associated with an MPD (media presentation description) and is managed in accordance with the MPD. The MPD is metadata of the content and describes management information of the content in XML format, the management information is being formulated with the use of DASH.

In other words, the MPD is information used in a case where the content reproducing device obtains and reproduces the content. The MPD has a function similar to that of a reproduction control metafile. That is, by describing, in the MPD, information such as entry information and attribute information, it is possible to realize adaptive streaming also with the use of DASH.

[Content Delivering System]

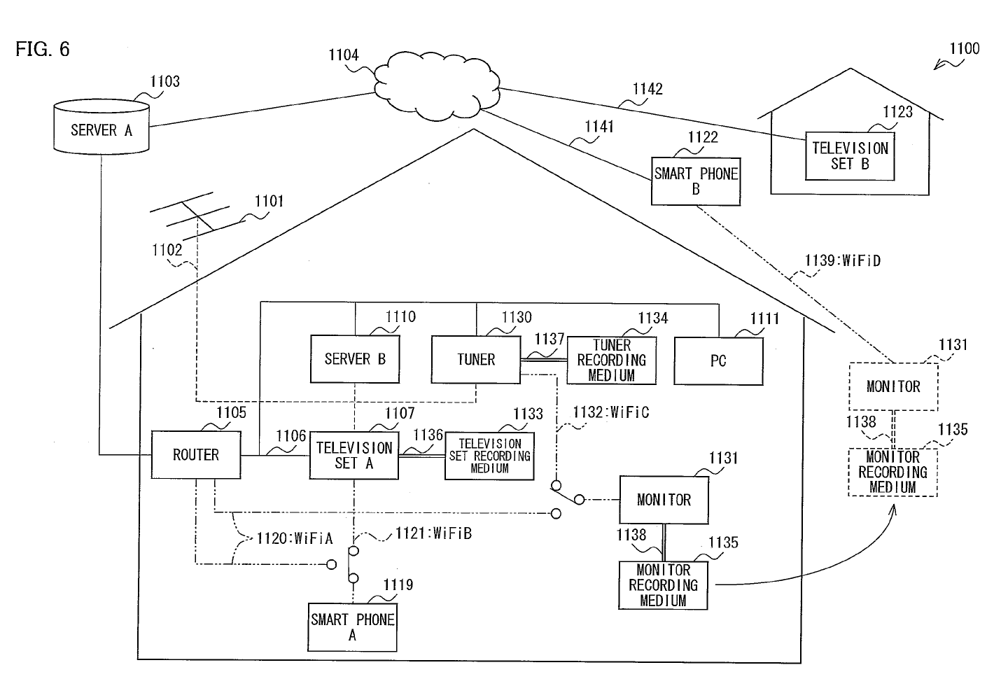

The following description will discuss, with reference to FIG. 6, a configuration of a content delivering system including the content reproducing device and the content delivering device in accordance with the present invention. FIG. 6 is a view illustrating an example configuration of a content delivering system in accordance with the present invention.

As illustrated in FIG. 6, a content delivering system 1100 includes an antenna 1101, a server A 1103, a cloud 1104, a router 1105, a television set A 1107, a server B 1110, a PC 1111, a smart phone A 1119, a smart phone B 1122, a television set B 1123, a tuner 1130, a monitor 1131, a television set recording medium 1133, a tuner recording medium 1134, and a monitor recording medium 1135.

The antenna 1101 is provided for receiving a broadcast. Note here that it is assumed to receive a digital broadcast or a satellite broadcast. However, a broadcast to be received can be other type of broadcast, such as an IP broadcast or a cable broadcast. The antenna 1101 is connected, via a cable 1102, to the television set A 1107, the server B 1110, and the tuner 1130. A broadcast wave received via the antenna 1101 is transmitted, via the cable 1102, to the television set A 1107, the server B 1110, and the tuner 1130. The cable 1102 is realized, for example, by a coaxial cable.

The server A 1103 is provided for offering a service to a device in a home or outside the home. The server A 1103 can be made up of a plurality of devices. Examples of services which the server A 1103 offers can encompass VOD, a video delivery service, a home device controller, video communication, security management.

The cloud 1104 includes a network and server devices on the network. The cloud 1104 includes, as the network, an Internet (IP) network, a mobile telephone network 1141, and a wired communication network (including public communication network) 1142. Note that the server A 1103 can be part of the cloud 1104.

The router 1105 is an access point/router which interconnects IP networks. The router 1105 is connected to the server A 1103. Note that, in a case where an external access network is established by an optical communication, an optical terminator and other devices are required. However, the optical terminator and the other devices are not illustrated because it is obvious to provide them in such a case. The router 1105 is further connected, via a wired LAN 1106, to the television set A 1107, the server B 1110, the tuner 1130, and the PC 1111. Note that, in general, the wired LAN 1106 has star network whose center is the router 1105. However, for simplification of description, the wired LAN 1106 has bus network here. Note also that IP communication in the home can be alternatively realized with the use of a wired LAN, a power-line LAN, a wireless LAN (including Wi-Fi (registered trademark)) alone or in combination.

The television set A 1107 is a digital television set which receives a broadcast wave and which is connected to the Internet.

The server B 1110 is a home server which receives a broadcast wave and then stores program data or stores data received via the Internet. The server B 1110 is preferably arranged to easily store a moving imaged or a still image captured by a camcorder, a digital camera, a digital video camera, a mobile phone, or the like, and is preferably arranged such that such data is duplicated through a data backup service on the cloud.

The smart phone A 1119 has a Wi-Fi wireless connection function. The smart phone A 1119 is connected to the router 1105 via Wi-Fi A 1120, and is connected to the television set A 1107 via Wi-Fi B 1121. The smart phone A1119 is directly connected to the television set A 1107 with the use of a technique referred to as Wi-Fi Direct. The smart phone A 1119 can be alternatively connected to the television set A 107 with the use of Bluetooth (registered trade mark). Note that there is no switch on a wireless network. However, for convenience of description, FIG. 6 illustrates as if a switch were provided so as to show that the smart phone A 1119 is capable of switching wireless networks between the Wi-Fi A 1120 and the Wi-Fi B 1121.

The smart phone B 1122 is a smart phone connectable to a home network via a public network. The smart phone B 1122 can be alternatively a tablet, a PC, or the like. The smart phone B 1122 can be connected, via the external network, to the network which has been closed in the home, for example, by (i) causing the smart phone B 1122 to transmit and receive information to/from a home device with the use of a mail, (ii) arranging, with the use of Dynamic DNS, the home device so as to be reached by the smart phone B 1122 via the external network, or (iii) causing an external server such as the server A 1103 to store temporary information so as to bridge the smart phone B 1122 and the home device. As just described, there are many methods of connecting the smart phone B 1122 to the home network via the public network. However, how the smart phone B 1122 is connected to the network which has been closed in the home is not limited to a specific method.

The television set B 1123 is a television set provided in another home. The television set B 1123 is used, for example, by being connected via video chatting or by being connected through a social net service. However, a detailed description will be omitted here.

The tuner 1130 is a tuner separately provided from one included in the television set A 1107. The tuner 1130 functions as a Wi-Fi access point and functions as a bridge between a wired LAN and a wireless LAN. The tuner 1130 is connected to the monitor 1131 via Wi-Fi C 1132. The tuner 1130 extracts video data, audio data, and the like from a broadcast wave received via the antenna 1101, forms the video data and the audio data so as to be in conformity with a streaming protocol, and then transmits the video data and the audio data to an IP network. Note that the streaming protocol to be employed during transmission can be a RTP or an HTTP. Note also that the tuner 1130 can be an STB (Set-top box). A detailed configuration of the tuner 1130 will be later described.

The monitor 1131 is connected to the tuner 1130 via a wireless network. The monitor 1131 obtains data of a broadcast program from the tuner 1130 via the Wi-Fi C 1132 or via the wired LAN 1106, the router 1105, and the Wi-Fi A 1120, and then reproduces video and audio. The monitor 1131 is also connected to the router 1105 via the Wi-Fi A 1120. The monitor 1131 can alternatively receive a VOD service or a video delivery service from the server A 1130, the cloud 1104, or the like via the router 1105, and then reproduce video and audio. Alternatively, the monitor 1131 can obtain data from the server B 1110, the television set A 1107, the PC 1111, or the like via the router 1105, and then reproduce video and audio. Alternatively, the monitor 1131 can be connected, outside the home via Wi-Fi D 1139, to the smart phone B 1122 which is connected to the cloud 1104 via the mobile telephone network 1141, and obtain video data and the like by use of so-called tethering. A detailed configuration of the monitor 1131 will be later described.

Note that the Wi-Fi C 1132, which is a wireless network similar to the Wi-Fi A 1120 but the Wi-Fi C 1132 is connected to the tuner 1130 which is an access point different from the router 1105. Note that there is no switch on a wireless network. However, for convenience of description, FIG. 6 illustrates as if a switch were provided so as to show that the monitor 1131 is capable of switching wireless networks between the Wi-Fi A 1120 and the Wi-Fi C 1132.

The television set recording medium 1133 is connected to the television set A 1107 via an interface 1136. The television set recording medium 1133 records video data, audio data, and/or the like.

The tuner recording medium 1134 is connected to the tuner 1130 via an interface 1137. The tuner recording medium 1134 records video data, audio data, and/or the like.

The monitor recording medium 1135 is connected to the monitor 1131 via an interface 1138. The monitor recording medium 1135 records video data, audio data, and/or the like.

Each of the television set recording medium 1133, the tuner recording medium 1134, and the monitor recording medium 1135 can be realized by a hard disk or a solid medium such as an SD or an SSD (Solid State Drive). Each of the interfaces 1136 through 1138 is not limited to any particular method/principle, provided that the each of the interfaces 1136 through 1138 can access to a recording medium. Examples of the interfaces 1136 through 1138 include an USB, an S-ATA, and an iLink.

In the present invention, the monitor 1131 and the smart phone A 1119 each serve as a content reproducing device, and the tuner 1130, the server A 1103, the cloud 1104, the server B 1110, the television set A 1107, the PC 1111, the smart phone B 1122 each serve as a content delivering device. The content delivering system 1100 in accordance with the present invention is only necessary to include at least one content reproducing device and at least one content data recording device.

Note that it can be said that the monitor 1131 and the smart phone A 1119 each serve both as (i) a content reproducing device and (ii) a content data recording device which records content data externally obtained.

[Configuration of Tuner]

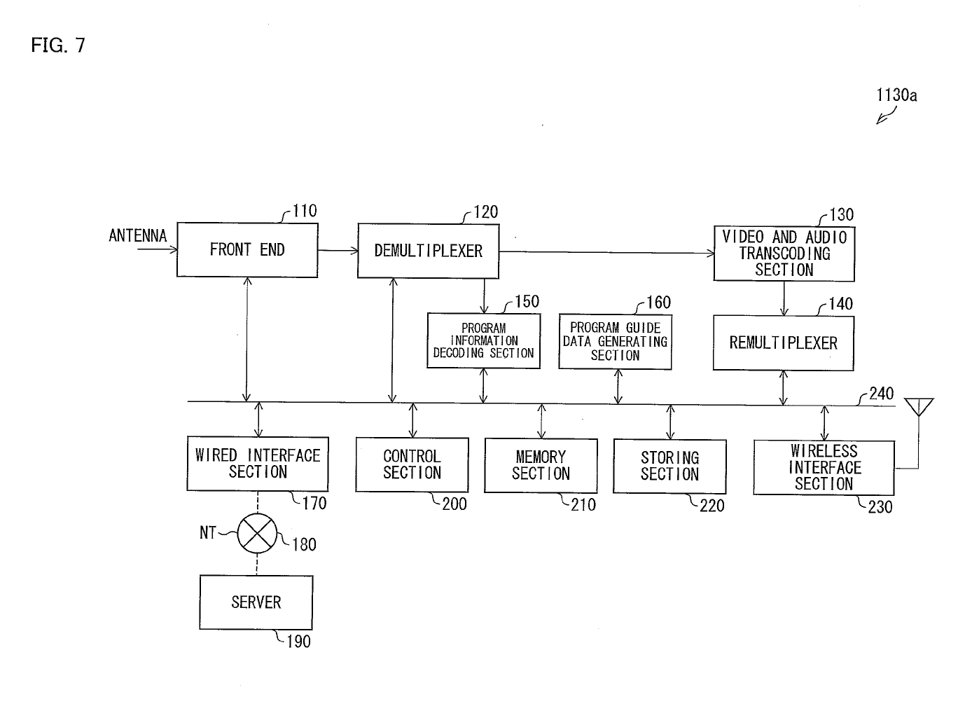

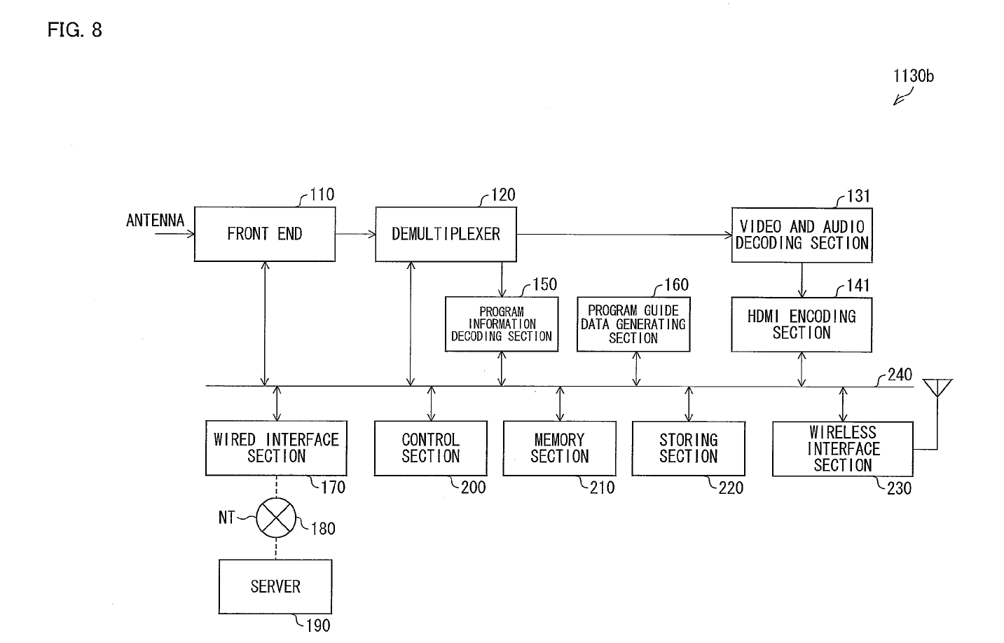

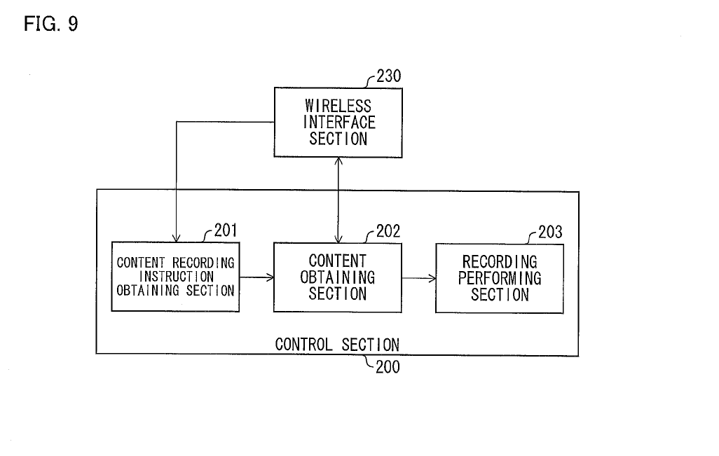

Next, a configuration of the tuner 1130 will be described in detail with reference to FIGS. 7 through 9. FIG. 7 is a block diagram illustrating an example configuration of a main part of a tuner 1130a which supplies data in TS format to a monitor 1131. FIG. 8 is a block diagram illustrating an example configuration of a main part of a tuner 1130b which supplies data in HDMI (High-Definition Multimedia Interface) format to a monitor 1131. FIG. 9 is a block diagram illustrating an example configuration of a main part of a control section of the tuner 1130.

(Configuration of Tuner which Outputs Data in TS Format)

First, a configuration of the tuner 1130a, illustrated in FIG. 7, which outputs data in TS format will be described. As illustrated in FIG. 7, the tuner 1130a includes a front end 110, a demultiplexer 120, a video and audio transcoding section 130, a remultiplexer 140, a program information decoding section 150, a program guide data generating section 160, a wired interface section 170, a control section 200, a memory section 210, a storing section 220, and a wireless interface section 230.

The front end 110 obtains a broadcast wave via the antenna 1101, and demodulates the broadcast wave thus obtained to digital data. The front end 110 supplies the digital data thus obtained to the demultiplexer 120.

The demultiplexer 120 demultiplexes the digital data, thus demodulated by the front end 110, into video data, audio data, program information data, and the like. The demultiplexer 120 supplies the video data and the audio data thus demultiplexed to the video and audio transcoding section 130, and supplies the program information data thus demultiplexed to the program information decoding section 150.

The video and audio transcoding section 130 obtains the video data and the audio data which have been demultiplexed by the demultiplexer 120, and then converts them into TS format. The video and audio transcoding section 130 supplies, to the remultiplexer 140, the video data and the audio data which have been converted into TS format.

The remultiplexer 140 obtains, from the video and audio transcoding section 130, the video data and the audio data which have been converted into TS format, and generates a data stream (TS stream) by integrating the video data and the audio data converted into TS format. Alternatively, the remultiplexer 140 can obtain (i) the video data and the audio data which have been converted into TS format from the video and audio transcoding section 130 and (ii) decoded program information data from the program information decoding section 150, and then generate a data stream by integrating the video data, the audio data, and the program information data. The remultiplexer 140 transmits the data stream thus generated to the content reproducing device via the wireless interface section 230.

The program information decoding section 150 obtains the program information data which has been demultiplexed by the demultiplexer 120, and then decodes the program information data thus obtained. The program information decoding section 150 stores, in the tuner recording medium 1134, the program information data thus decoded and supplies the program information data to the program guide data generating section 160 and the remultiplexer 140.

The program guide data generating section 160 obtains, from the program information decoding section 150, the program information data thus decoded, and generates, in accordance with the program information data thus obtained, program guide data indicative of an electric program guide which the content reproducing device is to display during being watched or during programming of video recording. The program guide data generating section 160 stores, in the tuner recording medium 1134, the program guide data thus generated or supplies the program guide data to the content reproducing device via the wireless interface section 230.

The wired interface section 170 interfaces the tuner 1130a to a network 180 such as a wired LAN (for example, the wired LAN 1106, the router 1105, and the like illustrated in FIG. 6). The wired interface section 170 also interfaces the tuner 1130a to another device (for example, the tuner recording medium 1134) by wire. The tuner 1130a is connected to an external server 190 (for example, the server A 1103, the cloud 1104, the television set A 1107, the server B 1110, the PC 1111, the tuner recording medium 1134, or the like illustrated in FIG. 6) via the wired interface section 170, and transmits and receives data to/from the external server 190.

The control section 200 carries out various calculations by executing a program which has been loaded in the memory section 210 from the storing section 220, and carries out overall control with respect to each section of the tuner 1130a. The control section 200 transmits, to the each section of the tuner 1130a, a control signal for controlling the each section, via a bus 240.

The memory section 210 temporarily stores therein data used or generated in a case where the control section 200 carries out the calculations. The memory section 210 is a so-called RAM (random access memory).

The storing section 220 stores therein a program used in a case where the control section 200 carries out the calculations. The storing section 220 is a non-volatile memory such as a so-called ROM (Read Only Memory) or a flash memory.

The wireless interface section 230 interfaces the tuner 1130a to wireless communication means such as Wi-Fi. The tuner 1130a transmits and receives data to/from another device having wireless communication means (for example, the content reproducing device such as the monitor 1131) via the wireless interface section 230.

(Configuration of Tuner which Outputs Data in HDMI Format)

Next, a configuration of the tuner 1130b, illustrated in FIG. 8, which outputs data in HDMI format will be described below. The tuner 1130b is different from the tuner 1130a in that the tuner 1130b includes a video and audio decoding section 131 and an HDMI encoding section 141, instead of the video and audio transcoding section 130 and the remultiplexer 140, respectively. Therefore, differences between the tuner 1130 b and the tuner 1130a will be mainly described here.

The video and audio decoding section 131 obtains video data and audio data which a demultiplexer 120 has demultiplexed, and decodes the video data and the audio data thus obtained. The video and audio decoding section 131 supplies the video data and the audio data thus decoded to the HDMI encoding section 141.

The HDMI encoding section 141 obtains the video data and the audio data thus decoded from the video and audio decoding section 131, and encodes the video data and the audio data thus obtained so that the video data and the audio data are compliant with the HDMI specification. The HDMI encoding section 141 transmits, to the content reproducing device, the video data and the audio data thus encoded, via a wireless interface section 230.

(Configuration of Control Section of Tuner)

Next, a configuration of the control section 200 illustrated in FIG. 9 will be described below. As illustrated in FIG. 9, the control section 200 includes functional blocks, i.e., a content recording instruction obtaining section 201, a content obtaining section 202, and a recording performing section 203. Each function of the functional blocks (the content recording instruction obtaining section 201, the content obtaining section 202, and the recording performing section 203) of the control section 200 can be realized by causing a CPU (Central Processing Unit) to load and execute, in the memory section 210 realized by an RAM or the like, a program stored in the storing section 220 realized by an ROM or the like.

The content recording instruction obtaining section 201 obtains a content recording instruction signal, which instructs content recording, from the content reproducing device via the wireless interface section 230. The content recording instruction obtaining section 201 supplies, to the content obtaining section 202, a reproduction control metafile of a content indicated by the content recording instruction signal. In a case where the tuner 1130 does not have the reproduction control metafile, the content recording instruction obtaining section 201 obtains the content recording instruction signal and then obtains the reproduction control metafile from the content delivering device.

The content obtaining section 202 obtains the reproduction control metafile from the content recording instruction obtaining section 201, and then obtains, in accordance with the reproduction control metafile thus obtained, high-quality data from the content delivering device. Note that the content obtaining section 202 can alternatively obtain high-quality data in synchronization with content reproduction carried out by the content reproducing device. Alternatively, the content obtaining section 202 can obtain high-quality data regardless of content reproduction carried out by the content reproducing device.

The recording performing section 203 stores, in the tuner recording medium 1134, high-quality data obtained by the content obtaining section 202.

[Configuration of Monitor]

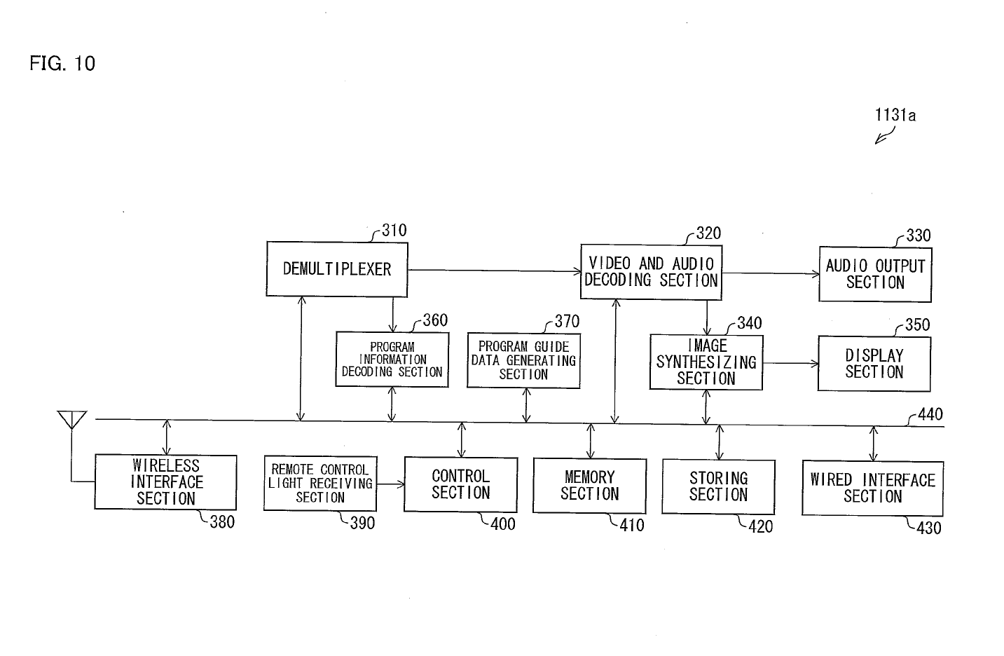

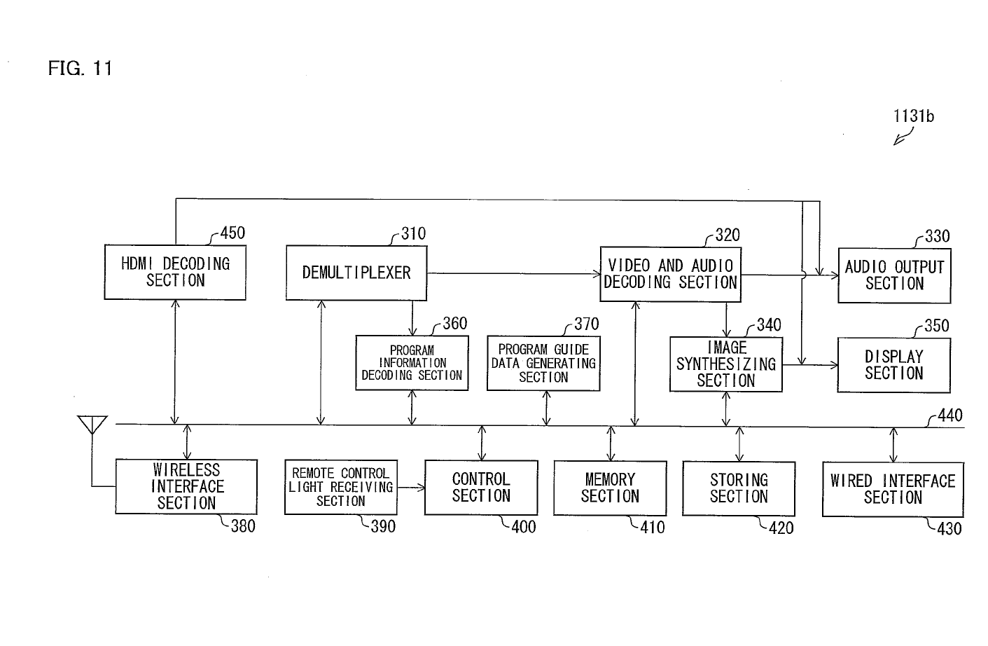

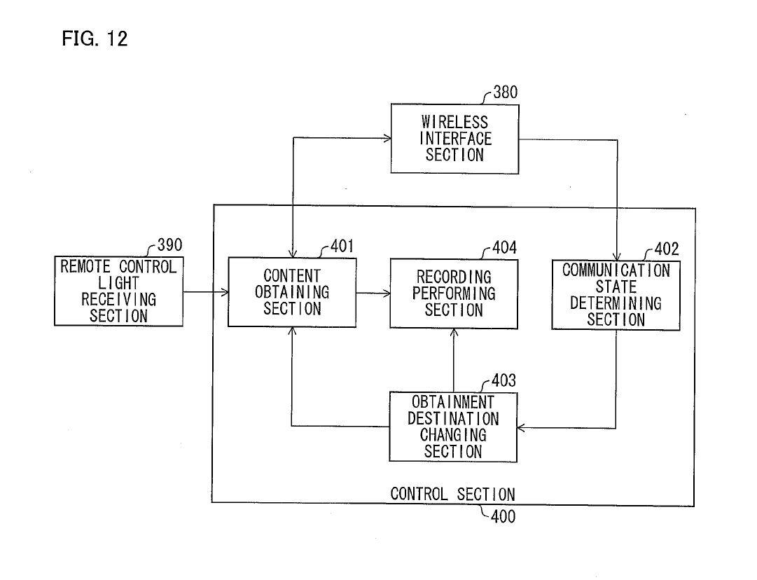

Next, a configuration of the monitor 1131 will be described below in detail with reference to FIGS. 10 through 12. FIG. 10 is a block diagram illustrating an example configuration of a main part of the monitor 1131a which receives data in TS format. FIG. 11 is a block diagram illustrating an example configuration of a main part of the monitor 1131b which receives data in TS format and data in HDMI format. FIG. 12 is a block diagram illustrating an example configuration of a main part of a control section of the monitor 1131.

(Configuration of Monitor for TS Input)

First, a configuration of the monitor 1131a, illustrated in FIG. 10, which receives data in TS format will be described. As illustrated in FIG. 10, the monitor 1131a includes a demultiplexer 310, a video and audio decoding section 320, an audio output section 330, an image synthesizing section 340, a display section 350, a program information decoding section 360, a program guide data generating section 370, a wireless interface section 380, a remote control light receiving section 390, a control section 400, a memory section 410, a storing section 420, and a wired interface section 430.

The demultiplexer 310 obtains, via the wireless interface section 380, a data stream supplied from the tuner 1130, and demultiplexes the data stream thus obtained into video data, audio data, program information data, and the like. The demultiplexer 310 supplies the video data and the audio data thus demultiplexed to the video and audio decoding section 320, and supplies the program information data thus demultiplexed to the program information decoding section 360.

The video and audio decoding section 320 obtains, from the demultiplexer 310, the video data and the audio data which have been demultiplexed, and then decodes the video data and the audio data thus obtained. The video and audio decoding section 320 can alternatively read out video data and audio data from the monitor recording medium 1135 via the wired interface section 430 and then decodes the video data and the audio data thus read out. The video and audio decoding section 320 supplies, to the audio output section 330, the audio data which has been decoded, and supplies, to the image synthesizing section 340, the video data which has been decoded.

The audio output section 330 converts, into sound, the audio data which has been received from the video and audio decoding section 320, and then outputs the sound outside the monitor 1131a. The audio output section 330 is a so-called speaker.

The image synthesizing section 340 generates an image in accordance with the video data which has been received from the video and audio decoding section 320. Alternatively, in addition to the video data, the image synthesizing section 340 can obtain data such as (i) program information data from the program information decoding section 360 and (ii) program guide data from the program guide data generating section 370, and generate an image in accordance with the video data, the program information data, the program guide data, and the like thus obtained. The image synthesizing section 340 supplies the image thus generated to the display section 350.

The display section 350 displays the image thus received from the image synthesizing section 340. Examples of the display section 350 encompass an LCD (liquid crystal display), an organic EL display, and a plasma display.

The program information decoding section 360 obtains, from the demultiplexer 310, the program information data which has been demultiplexed, and then decodes the program information data thus obtained. The program information decoding section 360 stores the program information data thus decoded in the monitor recording medium 1135 or supplies the program information data to the image synthesizing section 340 and the program guide data generating section 370.

The program guide data generating section 370 obtains, from the program information decoding section 360, the program information data which has been decoded, and generates program guide data in accordance with the program information data thus obtained. The program guide data generating section 370 stores the program guide data thus generated in the monitor recording medium 1135 or supplies the program guide data to the image synthesizing section 340.

The wireless interface section 380 interfaces the monitor 1131a to wireless communication means such as Wi-Fi. The monitor 1131a transmits and receives data to/from another device having wireless communication means (for example, a content delivering device such as the tuner 1130) via the wireless interface section 380.

The remote control light receiving section 390 receives light (for example, infrared light) from a remote control device (remote controller) of a monitor, and converts the light thus received into an electric signal (operation signal). The remote control light receiving section 390 supplies, to the control section 400, the operation signal thus converted. For example, the remote control light receiving section 390 supplies, to the control section 400, a content reproduction and recording signal which instructs reproduction and recording of a content.

The control section 400 carries out various calculations by executing a program which has been loaded in the memory section 410 from the storing section 420, and carries out overall control with respect to each section of the monitor 1131a. The control section 400 transmits, to the each section of the monitor 1131a, a control signal for controlling the each section, via a bus 440.

The memory section 410 temporarily stores therein data used or generated in a case where the control section 400 carries out the calculations. The memory section 410 is a so-called RAM.

The storing section 420 stores therein a program used in a case where the control section 400 carries out the calculations. The storing section 420 is a non-volatile memory such as a so-called ROM or a flash memory.

The wired interface section 430 interfaces the monitor 1131a to another device (for example, the monitor recording medium 1135) by wire.

(Configuration of Monitor for TS+HDMI Input)

Next, a configuration of the monitor 1131b, illustrated in FIG. 11, which receives data in TS format and data in HDMI format will be described below. The monitor 1131b is different from the monitor 1131a in that the monitor 1131b further includes an HDMI decoding section 450. Therefore, differences between the tuner 1130b and the tuner 1130a will be mainly described here.

The HDMI decoding section 450 obtains, from the tuner 1130, video data and audio data each of which is encoded so as to be compliant with the HDMI specification, via a wireless interface section 380. The HDMI decoding section 450 then decodes the video data and the audio data thus obtained. The HDMI decoding section 450 supplies the audio data thus decoded to an audio output section 330, and supplies the video data thus decoded to a display section 350.

(Configuration of Control Section of Monitor)

Next, a configuration of the control section 400 illustrated in FIG. 12 will be described below. As illustrated in FIG. 12, the control section 400 includes functional blocks, i.e., a content obtaining section 401, a communication state determining section 402, a section 403 for changing where to obtain a content, and a recording performing section (recording means) 404. Each function of the functional blocks (the content obtaining section 401, the communication state determining section 402, the section 403, and the recording performing section 404) of the control section 400 can be realized by causing a CPU to load and execute, in the memory section 410 realized by an RAM or the like, a program stored in the storing section 420 realized by an ROM or the like.

In a case where the content obtaining section 401 obtains a content reproduction and recording instruction signal from the remote control light receiving section 390, the content obtaining section 401 transmits a content request signal to the content delivering device via the wireless interface section 380. This causes the content obtaining section 401 to obtain a reproduction control metafile from the content delivering device via the wireless interface section 380. The content obtaining section 401 transmits, to the content delivering device, (i) a high-quality data request signal which requests high-quality data or (ii) a low-quality data request signal which requests low-quality data, in accordance with the reproduction control metafile.

In other words, the content obtaining section 401 has (i) a first obtaining section (first obtaining means) which obtains content data used to reproduce a content by streaming and which switches between obtainment of high-quality data and obtainment of low-quality data depending on a communication state and (ii) a second obtaining section (second obtaining means) which obtains part of the high-quality data which part has not been obtained by the first obtaining section, after the communication state is recovered. The second obtaining section can alternatively obtain the whole of part of the high-quality data which part corresponds to a segment including a time period during which the first obtaining section has not obtained the high-quality data, after the communication state is recovered. Alternatively, the obtainment of the high-quality data by the first obtaining section can be carried out simultaneously or simultaneously in part with the obtainment of the part of the high-quality data by the second obtaining section which part has not been obtained by the first obtaining section.

The communication state determining section 402 determines whether or not a wireless communication state between the wireless interface section 380 and another device is a state where the high-quality data is obtainable. For example, the communication state determining section 402 measures a radio field intensity which is received by wireless communication means. In a case where a measured radio field intensity is equal to or more than a predetermined intensity, the communication state determining section 402 can determine that the wireless communication state is the state where the high-quality data is obtainable. The communication state determining section 402 supplies a determined result to the section 403.

The section 403 obtains the determined result from the communication state determining section 402. In a case where the communication state determining section 402 determines that a wireless communication state is the state where the high-quality data is obtainable, the section 403 instructs the content obtaining section 401 to obtain the high-quality data. In a case where the communication state determining section 402 determines that a wireless communication state is not the state where the high-quality data is obtainable, the section 403 instructs the content obtaining section 401 to obtain the low-quality data. Further, the section 403 gives an instruction, to the content obtaining section 401, as to where to obtain the content, and notifies the recording performing section 404 of contents of such an instruction given to the content obtaining section 401. Alternatively, the section 403 can give an instruction to the content obtaining section 401 only in a case where the section 403 causes the content obtaining section 401 to change one content to be obtained to another.

The recording performing section 404 records (stores), in the monitor recording medium 1135, the high-quality data obtained by the content obtaining section 401. More specifically, the recording performing section 404 records (i) the high-quality data obtained by the first obtaining section and (ii) the high-quality data obtained by the second obtaining section.

[Reproduction and Recording Process Carried Out by Monitor]

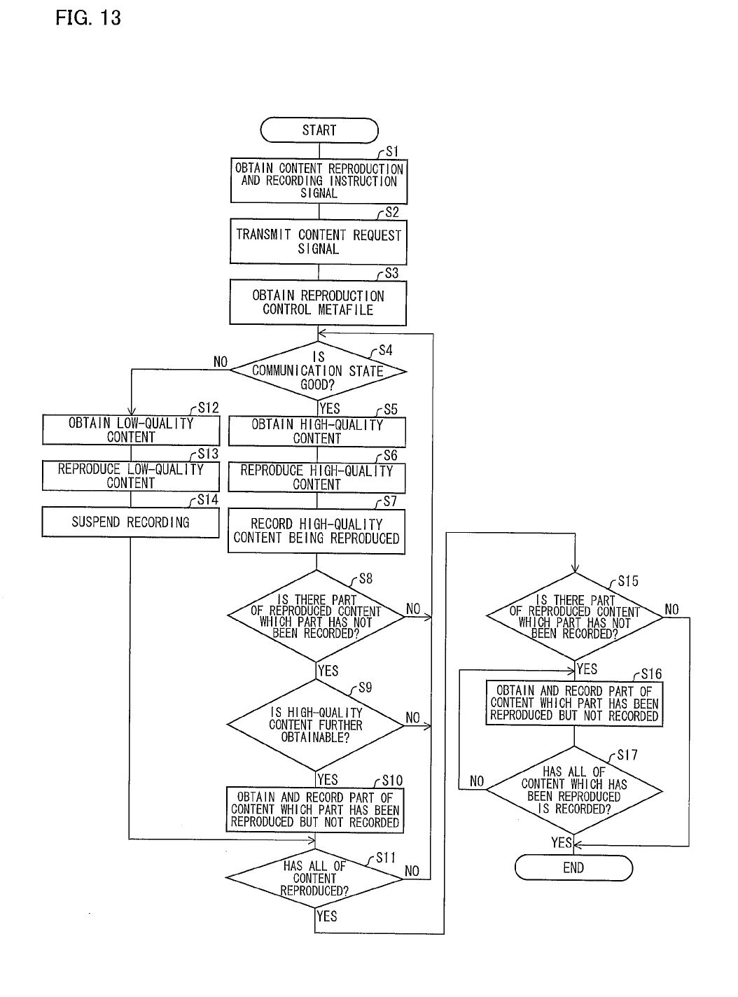

Next, a reproduction and recording process, in which the monitor 1131 records a content while reproducing the content, will be described below with reference to FIG. 13. FIG. 13 is a view illustrating an example of a reproduction and recording process carried out by the monitor 1131.

In a case where a user first inputs, with the use of the remote control device, an instruction to reproduce and record a content, the remote control light receiving section 390 receives infrared light from the remote control device and then converts the infrared light thus received into a content reproduction and recording instruction signal (see FIG. 13). The content obtaining section 401 obtains the content reproduction and recording instruction signal from the remote control light receiving section 390 (step S1). The content obtaining section 401 transmits, to the content delivering device, a content request signal for requesting a content indicated by the content reproduction and recording instruction signal thus obtained, via the wireless interface section 380 (step S2).

Upon receipt of the content request signal from the monitor 1131, the content delivering device transmits, to the monitor 1131, a reproduction control metafile of the content indicated by the content request signal. The content obtaining section 401 obtains the reproduction control metafile from the content delivering device (step S3). Here, the communication state determining section 402 determines whether or not a wireless communication state between the wireless interface section 380 and the content delivering device is a state where high-quality data is obtainable (step S4).

In a case where a wireless communication state is the state where the high-quality data is obtainable (Yes, in the step S4), the section 403 instructs the content obtaining section 401 to obtain the high-quality data. In response to the instruction, the content obtaining section 401 requests the high-quality data with respect to where to obtain the high-quality data. Note that where to obtain the high-quality data is indicated by the reproduction control metafile.

The monitor 1131 obtains the high-quality data via the wireless interface section 380 (step S5), and reproduces the high-quality data thus obtained (step S6). In this case, the recording performing section 404 stores obtained high-quality data (the high-quality data to be reproduced) in the monitor recording medium 1135 (step S7).

The recording performing section 404 determines whether or not there is part of a reproduced content in which part no high-quality data has been recorded (step S8). In a case where there is part of the reproduced content in which part no high-quality data has been recorded (Yes, in the step S8), the communication state determining section 402 determines whether or not the wireless communication state is a state where, in addition to part of the content in which part the high-quality data is to be reproduced, the part of the recorded content in which part no high-quality data has been recorded is further obtainable (step S9). In a case where the part of the recorded content in which part no high-quality data has been recorded is further obtainable (the step S9), the content obtaining section 401 requests the part of the recorded content in which part no high-quality data has been recorded, and the recording performing section 404 stores, in the monitor recording medium 1135, the part of the recorded content thus further obtained (step S10).

Here, the content obtaining section 401 determines whether or not obtainment of the content is completed, that is, whether or not all of the content has been reproduced (step S11). In a case where all of the content has not yet been reproduced, the process returns to the step S4. In a case where there is no part of the reproduced content in which part no high-quality data has been recorded (No, in the step S8), the process returns to the step S4. In a case where the wireless communication state is not the state where the part of the recorded content in which part no high-quality data has been recorded is further obtainable (No, in the step S9), the process also returns to the step S4.

On the other hand, in a case where the wireless communication state is not the state where the high-quality data is obtainable in the step S4 (No, in the step S4), the section 403 instructs the content obtaining section 401 to obtain low-quality data. In response to the instruction, the content obtaining section 401 requests the low-quality data with respect to where to obtain the low-quality data. Note that where to obtain the low-quality data is indicated by the reproduction control metafile.

The monitor 1131 obtains the low-quality data via the wireless interface section 380 (step S12), and reproduces the low-quality data thus obtained (step S13). In this case, the recording performing section 404 does not record the content (step S14). That is, the recording performing section 404 does not store, in the monitor recording medium 1135, the low-quality data which has been obtained.

The content obtaining section 401 then determines whether or not obtainment of the content is completed, that is, whether or not all of the content has been reproduced (step S11).

In a case where all of the content has been reproduced (Yes, in the step 11), the recording performing section 404 determines whether or not there is part of the content in which part no high-quality data has been recorded (step S15). In a case where there is part of the content in which part no high-quality data has been recorded (Yes, in the step S15), the content obtaining section 401 requests the part of the content in which part no the high-quality data has been recorded, and the recording performing section 404 stores, in the monitor recording medium 1135, the part of the content thus obtained (step S16). The recording performing section 404 carries out the step S16 until all of the content which has been reproduced is recorded with the use of the high-quality data (step S17). In a case where all of the content which has been reproduced is recorded with the use of the high-quality data (No, in the step S17 or S15), the monitor 1131 ends the reproduction and recording process.

### Example 1

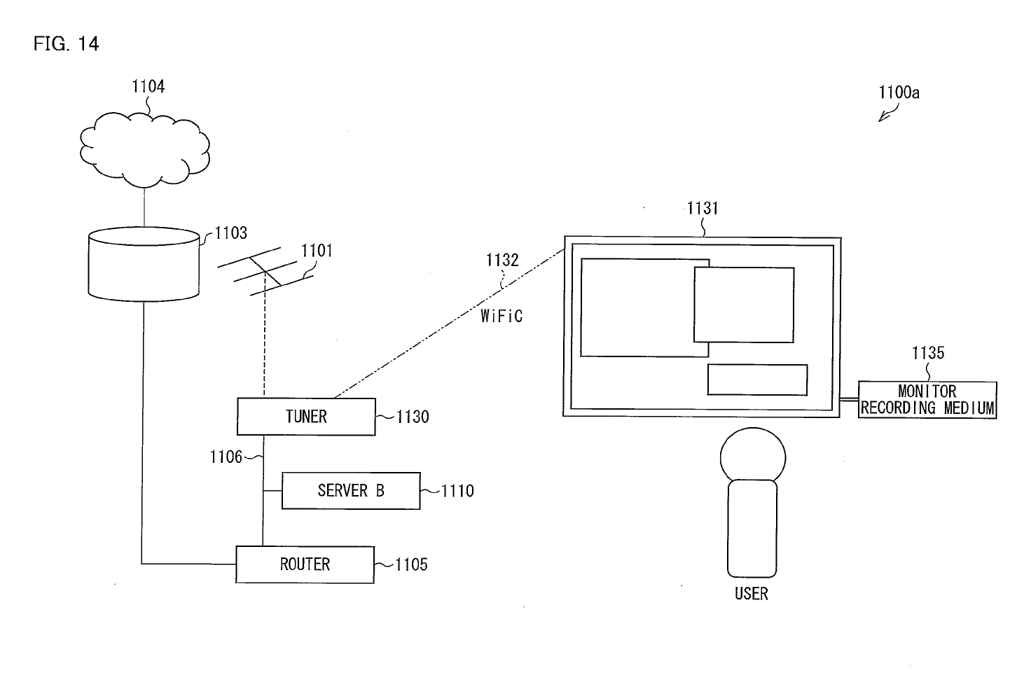

Next, the following description will discuss, with reference to FIGS. 14 through 16, a specific example of the reproduction and recording process carried out by the monitor 1131. FIGS. 14 through 16 are views each illustrating an example configuration of a content delivering system of Example 1.

In Example 1, it is assumed that a user moves while (i) watching a moving image (content) on a monitor 1131 connected to a wireless network and (ii) the moving image is being recorded. The moving image to be watched is not limited to any particular one, provided that the moving image uses a reproduction control metafile. As such, for example, the moving image can be one provided through a VOD service from a cloud 1104 or a server A1103 or one provided from a server B 1110 in a home.

Specifically, as illustrated in FIG. 14, a content delivering system 1100a includes a monitor 1131, a cloud 1104, and a server A 1103. The monitor 1131 serves as a content reproducing device, and each of the cloud 1104 and the server A 1103 serves as a content delivering device. According to an example illustrated in FIG. 14, (i) the cloud 1104 and the server A 1103 are connected to a tuner 1130 via a router 1105 and (ii) the tuner 1130 is connected, by wireless, to the monitor 1131 via Wi-Fi C 1132.

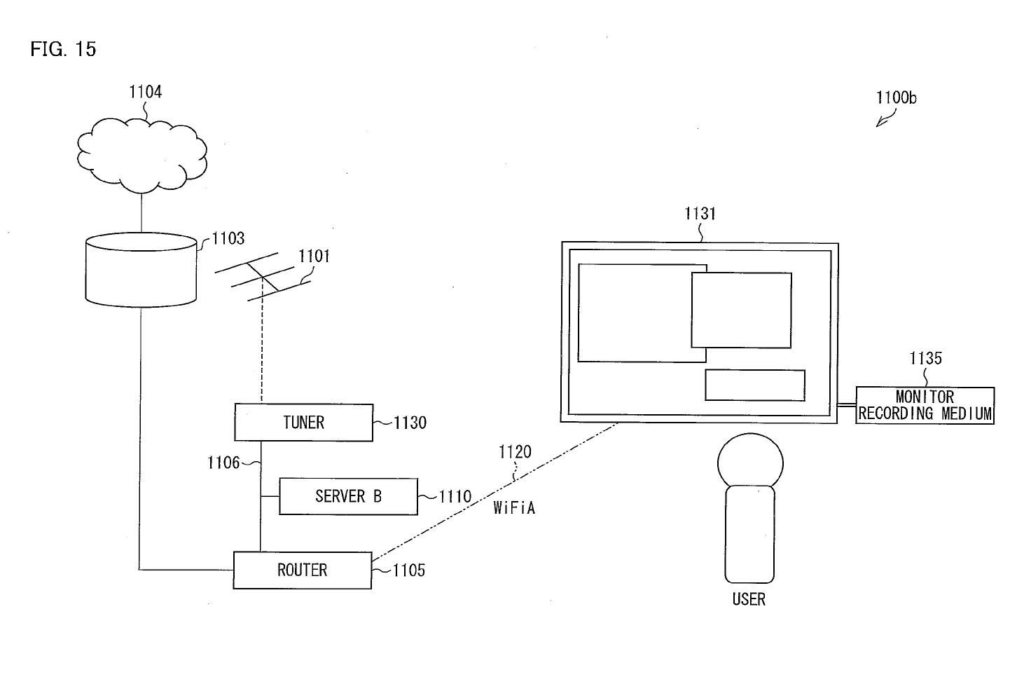

According to an example illustrated in FIG. 15, a content delivering system 1100b includes a monitor 1131, a cloud 1104, and a server A 1103. The monitor 1131 serves as a content reproducing device, and each of the cloud 1104 and the server A 1103 serves as a content delivering device. In FIG. 15, (i) the cloud 1104 and the server A 1103 are connected to a router 1105 and (ii) the router 1105 is connected, by wireless, to the monitor 1131 via Wi-Fi A 1120.

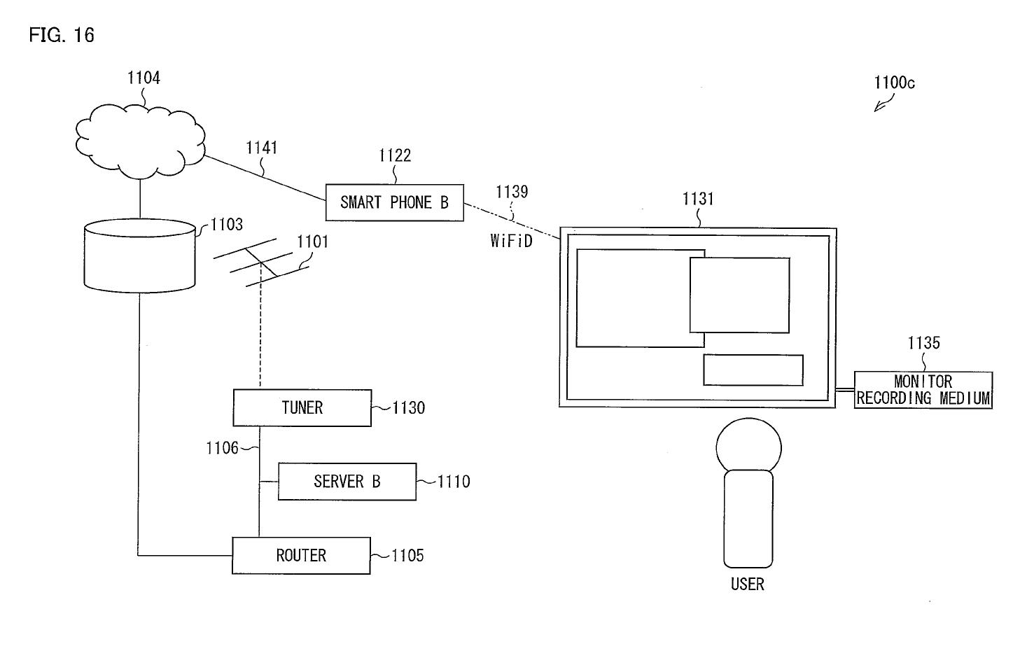

According an example illustrated in FIG. 16, a content delivering system 1100c includes a monitor 1131, a cloud 1104, and a server A 1103. The monitor 1131 serves as a content reproducing device, and each of the cloud 1104 and the server A 1103 serves as a content delivering device. In FIG. 16, (i) the cloud 1104 and the server A 1103 are connected to a smart phone B 1122 via a mobile telephone network 1141 and (ii) the smart phone B 1122 is connected, by wireless, to the monitor 1131 via Wi-Fi D 1139.

A communication connection state between the content reproducing device and the content delivering device is switched to the most suitable state, by the user moving inside or out of the home while holding the monitor 1131.

Even in a case where the communication connection state is switched to the most suitable state, a wireless communication state between the content reproducing device and the content delivering device sometimes becomes poor due to an obstacle on the wireless network. In a case where the wireless communication state is poor between the content reproducing device and the content delivering device, it is difficult to normally reproduce the content while maintaining a quality of the content. Similarly, in a case where (i) the wireless communication state is poor between the content reproducing device and the content delivering device and (ii) the content is recorded while being reproduced, it is difficult to record the content in the monitor recording medium 1135 without an error.

In view of the circumstances, switching between obtainment of high-quality data and obtainment of low-quality data is carried out, with reference to a reproduction control metafile, in accordance with the wireless communication state. This allows the content to be reproduced without an error even in a case where the wireless communication state becomes poor.

In a case where the content is recorded while being reproduced, recording of the content is suspended at a time of changing the obtainment of content so that the content is obtained from where to obtain the low-quality data. The recording of the content is then resumed at a time of changing the obtainment of the content so that the content is obtained from where to obtain the high-quality data, after the wireless communication state is improved. In this case, a speed of the recording is not necessary to synchronize with a speed of reproduction. In a case where a bandwidth of the wireless network is sufficient, the speed of the recording can be faster than that of the reproduction. Alternatively, in a case where the bandwidth of the wireless network is not sufficient, the speed of the recording can be slower than that of the reproduction. In a case where the content is divided into a plurality of segments, the plurality of segments can be recorded on a segment basis in order of reproduction. Alternatively, the plurality of segments can be recorded on a segment basis in order different from the order of reproduction.

In a case where (i) the recording is to be resumed and (ii) the content is obtainable from where to refer to a single piece of entry information, positional information, indicative of a time or a byte in the middle of the content from which time or byte the recording of the content is to be resumed, is transmitted to a VOD server, then moving image data is obtained from the middle thereof, and the recording is resumed. In this regard, it is difficult to determine an accurate position, in a recorded moving image, at which an error has started to occur. In a case where the VOD service is offered with the use of an RTP as a protocol, it is particularly difficult to determine an accurate position, in a recorded moving image, at which an error has started to occur.

In view of the circumstances, it is general to again obtain the moving image data from the beginning thereof in order to obtain a complete content. Such a problem, however, can be solved as follows. Namely, in a case where a content is time-divided into a plurality of segments as illustrated in FIG. 4, segment data from 0 (zero) minute to 15 minutes contains no error, because the segment data has been already recorded, even if, for example, a communication state becomes poor 17 minutes later from start of reproduction of the content so that an error occurs in a recorded moving image. As such, it is possible to record a complete content, by merely obtaining and recording segment data from 15 minutes to 30 minutes again. In this case, the moving image data from 15 minutes to 17 minutes which is recorded while being reproduced is destroyed because the moving image data is considered to contain an error. According to the example illustrated in FIG. 4, a 30-minute content is divided into two 15-minute segments. However, in a case where the 30-minute content is, for example, divided into 30-second segments, it is possible to reduce recorded data to be destroyed in a case where an error occurs.

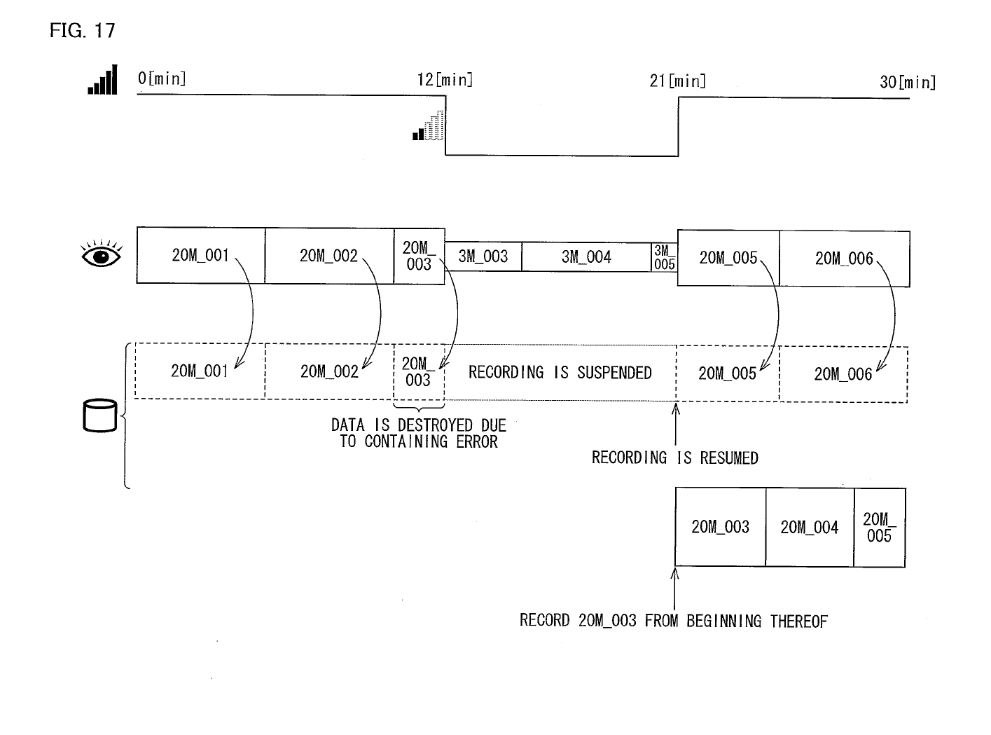

Next, with reference to FIGS. 17 through 19, a reproduction and recording process will be described in detail below which is carried out by the content reproducing device in a case where a content is associated with a reproduction control metafile as illustrated in FIG. 5. FIGS. 17 through 19 are views each illustrating, with respect to a time axis of reproduction of a content, (i) a wireless communication state between the content reproducing device and the content delivering device, (ii) content data reproduced by the content reproducing device, and (iii) the content data recorded by the content reproducing device.

Note, here, that each content has two types of data which are different in quality, i.e., high-quality data and low-quality data, as illustrated in FIG. 5. It is assumed that each reproduction time of the high-quality data and the low-quality data is 30 minutes and each of the high-quality data and the low-quality data is time-divided into six segments. That is, a time length of each of the six segments is assumed to be five minutes.

It is also assumed that the wireless communication state (i) is good at start (0 (zero) minute) of the reproduction of the content, (ii) becomes poor 12 minutes later from the start of the reproduction, and (iii) is then improved 21 minutes later from the start of the reproduction.

As illustrated in FIG. 17, the content is reproduced as follows. Specifically, during a time period from 0 (zero) minute to 12 minutes, a content obtaining section 401 sequentially obtains “20M_{—}001.tts”, “20M_{—}002.tts”, and “20M_{—}003.tts” from where to obtain the high-quality data. In accordance with the high-quality data thus obtained, the content is reproduced. During a time period from 12 minutes to 21 minutes, the content obtaining section 401 first switches from where to obtain the high-quality data to where to obtain the low-quality data. The content obtaining section 401 then transmits, to a VOD server (the cloud 1104 or the server A 1103), positional information indicative of a position ahead, by 2 minutes, of the beginning of the third segment (indicative of 12 minutes or a byte), and obtains the low-quality data from the middle of a low-quality third segment. In accordance with the low-quality data thus obtained, the content is reproduced. During a time period from 21 minutes to 30 minutes, the content obtaining section 401 switches from where to obtain the low-quality data to where to obtain the high-quality data. The content obtaining section 401 then transmits, to the VOD server, positional information indicative of a position ahead, by 1 (one) minute, of the beginning of the fifth segment (indicative of 21 minutes or a byte), and obtains the high-quality data from the middle of a high-quality fifth segment. In accordance with the high-quality data thus obtained, the content is reproduced.

Recording of the content is carried out as follows. During the time period from 0 (zero) minute to 12 minutes, since the content obtaining section 401 has obtained the high-quality data, which is to be reproduced by streaming, the recording performing section 404 records the high-quality data, as it is, obtained by the content obtaining section 401. During the time period from 12 minutes to 21 minutes, since the content obtaining section 401 has obtained the low-quality data, which is to be reproduced by streaming, the recording performing section 404 suspends recording of the content and will not record the low-quality data obtained by the content obtaining section 401. In doing so, data from 10 minutes to 12 minutes of a high-quality third segment, which data has been recorded right before the content obtaining section 401 switches where to obtain the content data, is considered to contain an error and is accordingly destroyed. During a time period from 21 minutes to 30 minutes, the content obtaining section 401 has obtained the high-quality data, which is to be reproduced by streaming. Therefore, the recording performing section 404 records the high-quality data, as it is, obtained by the content obtaining section 401. Note that, according to an example illustrated in FIG. 17, since it is possible to use, during the time period from 21 minutes to 30 minutes, another bandwidth different from that used to view the content, the content obtaining section 401 obtains part, from 10 minutes to 21 minutes, of the high-quality data which part has not been recorded (the high-quality third segment, a high-quality fourth segment, and part of a high-quality fifth segment), and the recording performing section 404 records the part of the high-quality data. Note here that a speed of obtaining the part of the high-quality data which part has not been recorded is not necessary to synchronize with a speed of the reproduction. In a case where a bandwidth of a wireless network is sufficient, the speed of obtaining the part of the high-quality data can be faster than that of the reproduction. Alternatively, in a case where the bandwidth of the wireless network is not sufficient, the speed of obtaining the part of the high-quality data can be slower than that of the reproduction. According to the example illustrated in FIG. 17, the part of the high-quality data which part has not been recorded is obtained at a speed faster than the speed of the reproduction and then recorded.

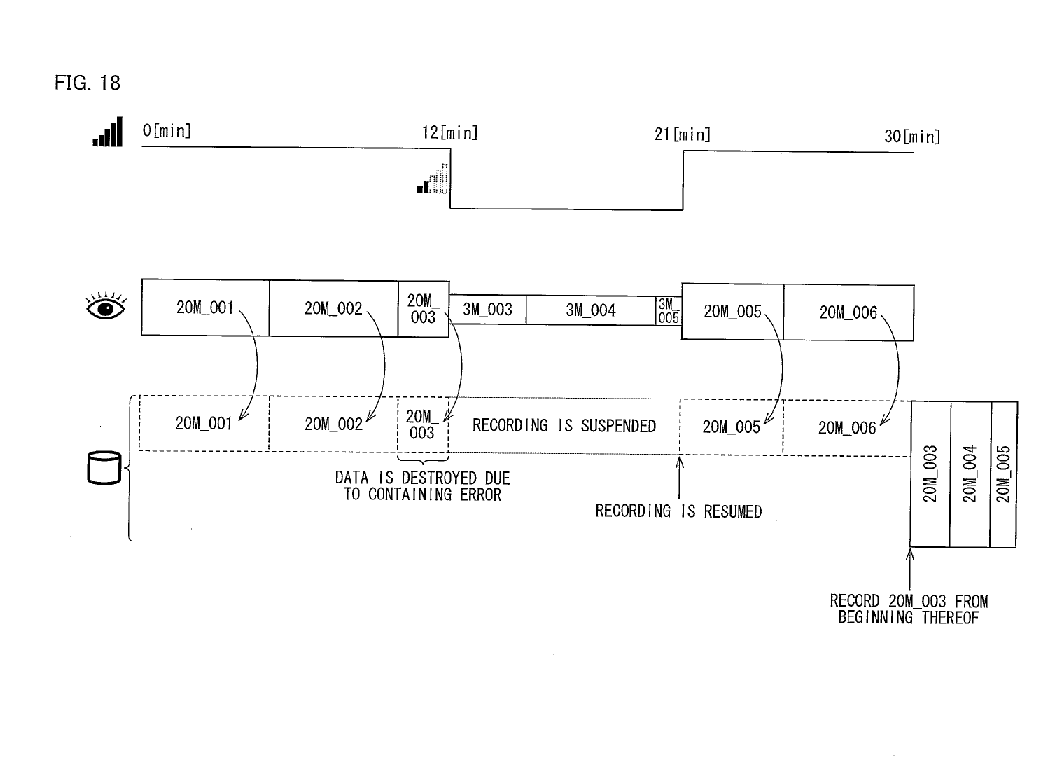

According to an example illustrated in FIG. 18, a case is illustrated where, for example, (i) a bandwidth is secured for viewing or (ii) priority is given to integration of a moving content to be received. In this case, priority is given to reproduction of a content, and part, from 10 minutes to 21 minute, of high-quality data which part has not been recorded is obtained and recorded after the reproduction of the content is completed. Note here that a speed of obtaining the part of the high-quality data which part has not been recorded is not necessary to synchronize with a speed of the reproduction. In a case where a bandwidth of a wireless network is sufficient, the speed of obtaining the part of the high-quality data can be faster than that of the reproduction. Alternatively, in a case where the bandwidth of the wireless network is not sufficient, the speed of obtaining the part of the high-quality data can be slower than that of the reproduction. According to the example illustrated in FIG. 18, the part of the high-quality data which part has not been recorded is obtained at a speed faster than the speed of the reproduction and then recorded.

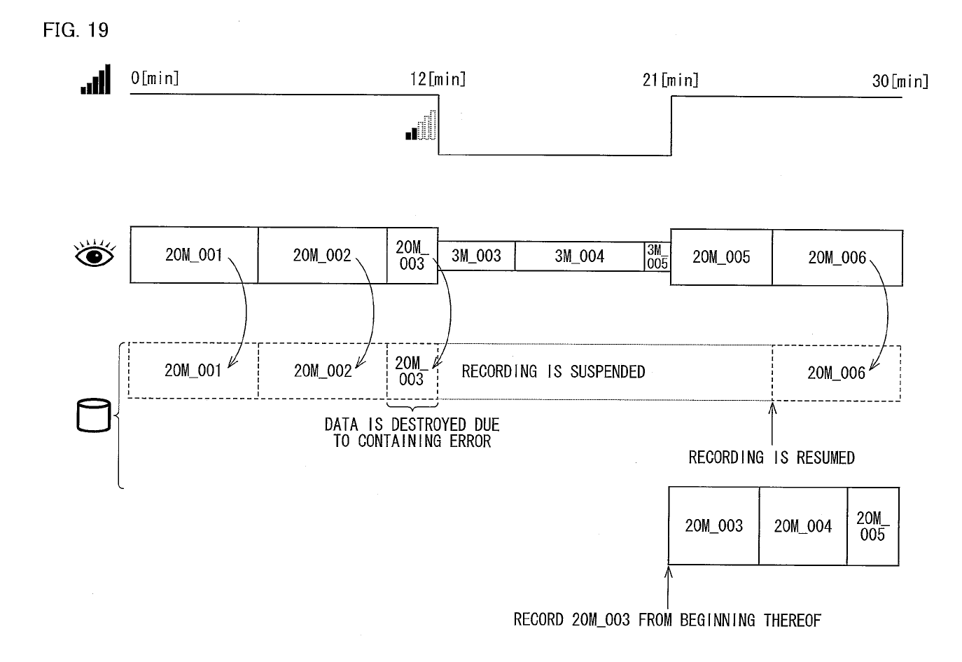

According to an example illustrated in FIG. 19, a content is recorded on a segment basis. That is, during a time period from 0 minute to 12 minutes, the recording performing section 404 records a high-quality first segment and a high-quality second segment, as they are, each obtained by the content obtaining section 401. A high-quality third segment is obtained only partway and is accordingly destroyed without being recorded. During a time period from 21 minutes to 30 minutes, the content obtaining section 401 obtains a high-quality fifth segment from the middle thereof. Therefore, the recording performing section 404 does not record the high-quality fifth segment to be reproduced by streaming, but records a high-quality sixth segment from the beginning thereof. Note, however, that a communication state is good from 21 minutes. Therefore, from 21 minutes, the content obtaining section 401 sequentially obtains the high-quality third segment, a high-quality fourth segment, and the high-quality fifth segment, each of which has not been recorded, and the recording performing section 404 records the high-quality third segment, the high-quality fourth segment, and the high-quality fifth segment. In this case, a speed of obtaining part of high-quality data which part has not been recorded is not necessary to synchronize with a speed of reproduction. In a case where a bandwidth of a wireless network is sufficient, the speed of obtaining the part of the high-quality data can be faster than that of the reproduction. Alternatively, in a case where the bandwidth of the wireless network is not sufficient, the speed of obtaining the part of the high-quality data can be slower than that of the reproduction. According to the example illustrated in FIG. 19, the part of the high-quality data is obtained at a speed faster than the speed of the reproduction and then recorded.

[Transfer Recording Process Carried Out by Tuner]

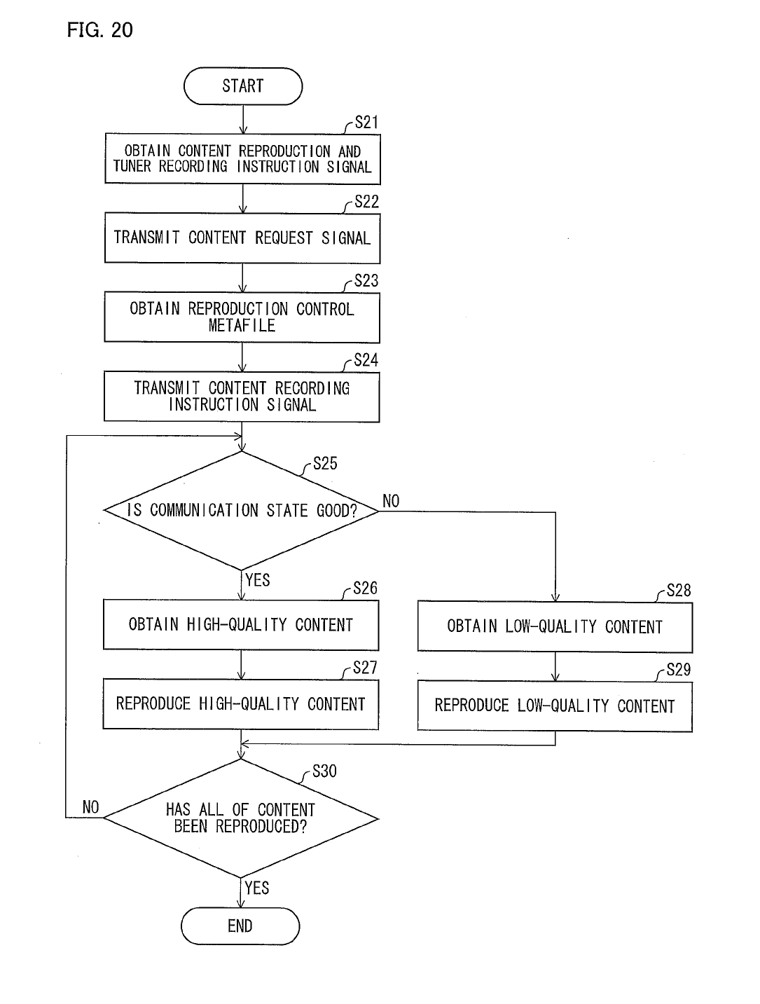

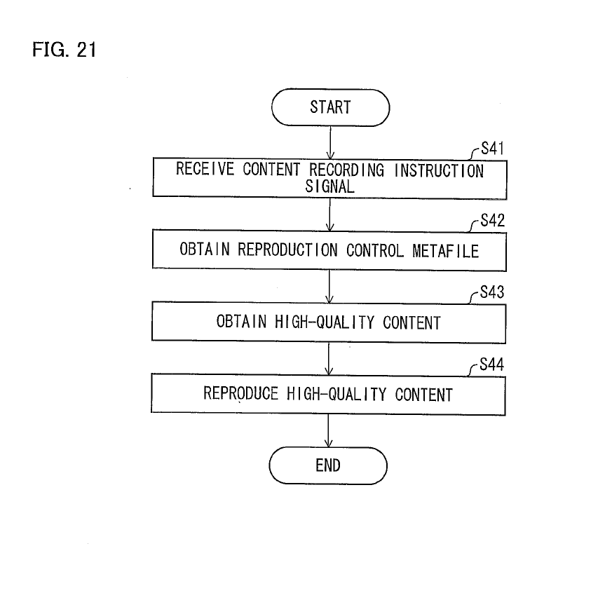

Next, with reference to FIGS. 20 and 21, the following description will discuss a transfer recording process, carried out by the tuner 1130, in which a content transmitted by the content delivering device is transferred to the content reproducing device and the content is recorded with the use of high-quality data. FIG. 20 is a view illustrating an example of a reproduction process carried out by the monitor 1131 in a case where the tuner 1130 carries out the transfer recording process. FIG. 21 is a view illustrating an example of the transfer recording process carried out by the tuner 1130.

In a case where a user first inputs, with the use of a remote control device, an instruction to reproduce a content and to cause the tuner 1130 to record the content, a remote control light receiving section 390 receives infrared light from the remote control device and then converts the infrared light thus received into a content reproduction and tuner recording instruction signal (see FIG. 20). The content obtaining section 401 obtains the content reproduction and tuner recording instruction signal from the remote control light receiving section 390 (step S21). The content obtaining section 401 transmits, to the content delivering device, a content request signal for requesting a content indicated by the content reproduction and tuner recording instruction signal thus obtained, via the wireless interface section 380 and the tuner 1130 (step S22).

Upon receipt of the content request signal from the monitor 1131, the content delivering device transmits, to the monitor 1131 via the tuner 1130, a reproduction control metafile of the content indicated by the content request signal. The content obtaining section 401 obtains the reproduction control metafile from the content delivering device (step S23). In a case where the content obtaining section 401 obtains the reproduction control metafile, the content obtaining section 401 transmits a content recording instruction signal to the tuner 1130 (step S24).

Here, the communication state determining section 402 determines whether or not a wireless communication state between the wireless interface section 380 and the content delivering device is a state where high-quality data is obtainable (step S25).

In a case where a wireless communication state is the state where the high-quality data is obtainable (Yes, in the step S25), a section 403, for changing where to obtain a content, instructs the content obtaining section 401 to obtain the high-quality data. In response to this instruction, the content obtaining section 401 requests the high-quality data with respect to where to obtain the high-quality data. Note that where to obtain the high-quality data is indicated by the reproduction control metafile. The monitor 1131 obtains the high-quality data via the tuner 113Q and the wireless interface section 380 (step S26), and reproduces the high-quality data thus obtained (step S27).

Here, the content obtaining section 401 determines whether or not obtainment of the content is completed, that is, whether or not all of the content has been reproduced (step S30). In a case where all of the content has not yet been reproduced, the process returns to the step S25.

In a case where the wireless communication state is not the state where the high-quality data is obtainable (No, in the step S25), the section 403 instructs the content obtaining section 401 to obtain low-quality data. In response to the instruction, the content obtaining section 401 requests the low-quality data with respect to where to obtain the low-quality data. Note that where to obtain the low-quality data is indicated by the reproduction control metafile.

The monitor 1131 obtains the low-quality data via the tuner 1130 and the wireless interface section 380 (step S28), and reproduces the low-quality data thus obtained (step S29). Thereafter, the content obtaining section 401 determines whether or not the obtainment of the content is completed, that is, whether or not all of the content has been reproduced (step S30).

In a case where all of the content has been reproduced (Yes, in the step 30), the monitor 1131 ends the reproduction process.

Meanwhile, as illustrated in FIG. 21, a content recording instruction obtaining section 201 first receives the recording instruction signal from the monitor 1131 (step S41). The content recording instruction obtaining section 201 further receives the reproduction control metafile from the monitor 1131 (step S42). Note that, in a case where the reproduction control metafile is transmitted to the content reproducing device from the content delivering device via the tuner 1130, the tuner 1130 can transfer the reproduction control metafile to the content reproducing device and hold a copy of the reproduction control metafile.

A content obtaining section 202 obtains the high-quality data of the content in accordance with the reproduction control metafile (step S43). A recording performing section 203 then stores, in a tuner recording medium 1134, the high-quality data obtained by the content obtaining section 202 (step S44).

### Example 2

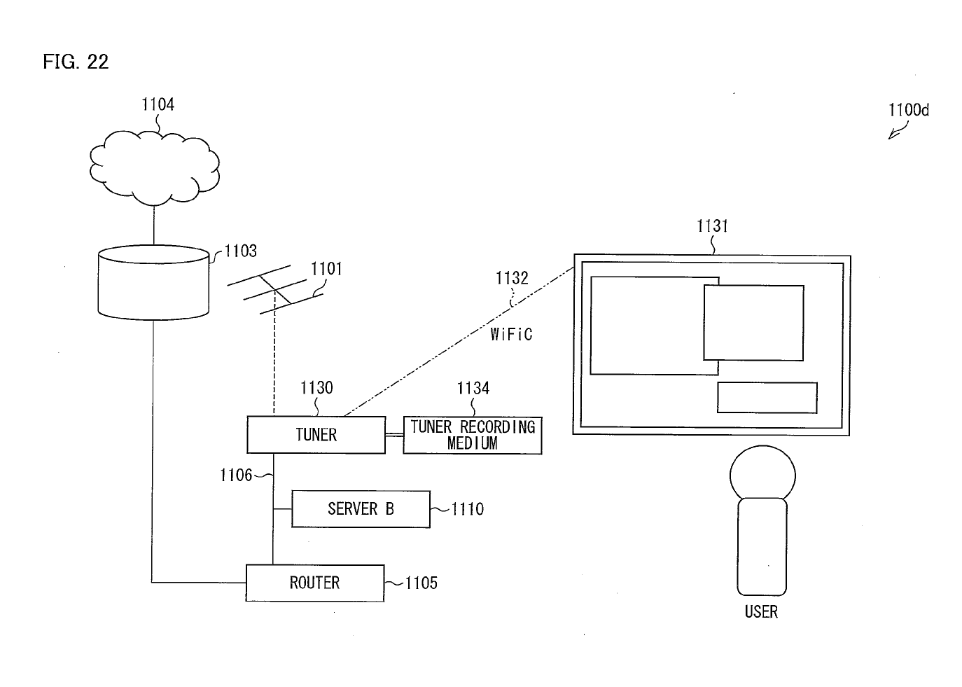

The following description will discuss, with reference to FIGS. 22 through 24, a specific example of the transfer recording process carried out by the tuner 1130. FIGS. 22 through 24 are views each illustrating an example configuration of a content delivering system of Example 2.

In Example 2, it is assumed that a user moves while (ii) watching a moving image (content) on a monitor 1131 connected to a wireless network. The moving image to be watched is not limited to any particular one, provided that the moving image uses a reproduction control metafile. As such, for example, the moving image can be one provided through a VOD service from a cloud 1104 or a server A1103 or one provided from a server B 1110 in a home.

Specifically, as illustrated in FIG. 22, a content delivering system 1100d includes a monitor 1131, a tuner 1130, a cloud 1104, and server A 1103. The monitor 1131 serves as a content reproducing device, and each of the cloud 1104 and the server A 1103 serves as a content delivering device. According to an example illustrated in FIG. 22, (i) the cloud 1104 and the server A 1103 are connected to the tuner 1130 via a router 1105 and (ii) the tuner 1130 is connected, by wireless, to the monitor 1131 via Wi-Fi C 1132.

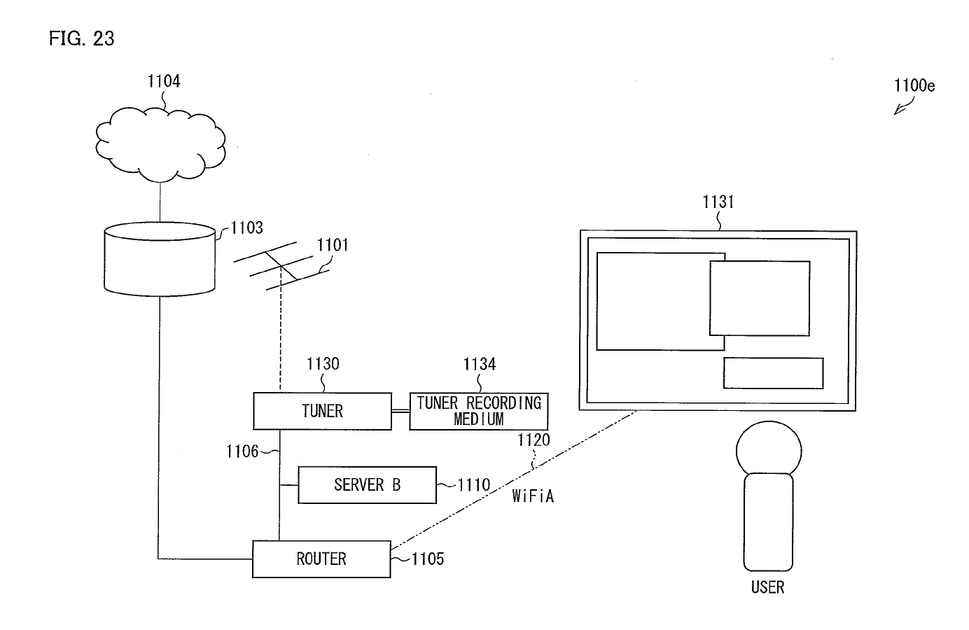

Further, according to an example illustrated in FIG. 23, a content delivering system 1100e includes a monitor 1131, a tuner 1130, a cloud 1104, and a server A 1103. The monitor 1131 serves as a content reproducing device, and each of the cloud 1104 and the server A 1103 serves as a content delivering device. In FIG. 23, (i) the cloud 1104 and the server A 1103 are connected to a router 1105 and (ii) the router 1105 is connected, by wireless, to the monitor 1131 via Wi-Fi A 1120. The tuner 1130 is connected to the cloud 1104 and the server A 1103 via the router 1105.

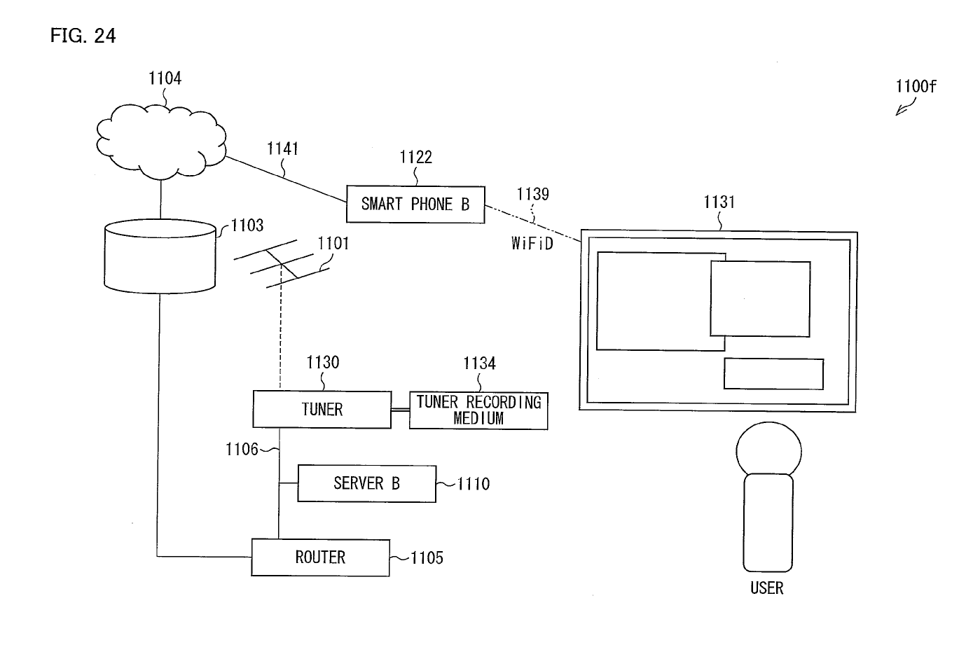

According to an example illustrated in FIG. 24, a content delivering system 1100f includes a monitor 1131, a smart phone B 1122, a cloud 1104, and a server A 1103. The monitor 1131 serves as a content reproducing device, and each of the cloud 1104 and the server A 1103 serves as a content delivering device. In FIG. 24, (i) the cloud 1104 and the server A 1103 are connected to the smart phone B 1122 via a mobile telephone network 1141 and the smart phone B 1122 is connected, by wireless, to the monitor 1131 via Wi-Fi D 1139. The tuner 1130 is connected to the cloud 1104 and the server A1103 via the router 1105.

A communication connection state between the content reproducing device and the content delivering device is switched to the most suitable state, by the user moving inside or out of the home while holding the monitor 1131.

Even in a case where the communication connection state is switched to the most suitable state, a wireless communication state between the content reproducing device and the content delivering device sometimes becomes poor due to an obstacle on the wireless network. In a case where the wireless communication state is poor between the content reproducing device and the content delivering device, it is difficult to normally reproduce the content while maintaining a quality of the content.

In view of the circumstances, switching between obtainment of high-quality data and obtainment of low-quality data is carried out, with reference to a reproduction control metafile, in accordance with the wireless communication state. This allows the content to be reproduced without an error even in a case where the wireless communication state becomes poor.

In a case of recording the content, the tuner 1130 is capable of recording the content with the use of the high-quality data, regardless of a Wi-Fi wireless communication state, because the tuner 1130 is connected to the cloud 1104 and the server A 1103 by wire and shares the reproduction control metafile with the monitor 1131.

In this case, a speed of recording is not necessary to synchronize with a speed of reproduction. In a case where a bandwidth of a wireless network is sufficient, the speed of the recording can be faster than that of the reproduction. Alternatively, in a case where the bandwidth of the wireless network is not sufficient, the speed of the recording can be slower than that of the reproduction. In a case where the content is divided into a plurality of segments, the plurality of segments can be recorded on a segment basis in order of reproduction. Alternatively, the plurality of segments can be recorded on a segment basis in order different from the order of reproduction.

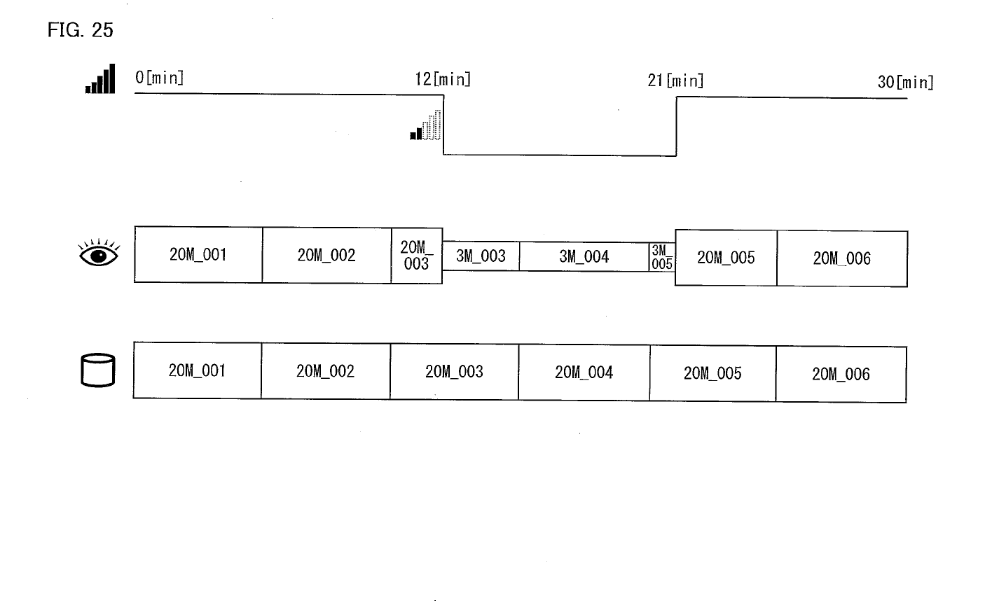

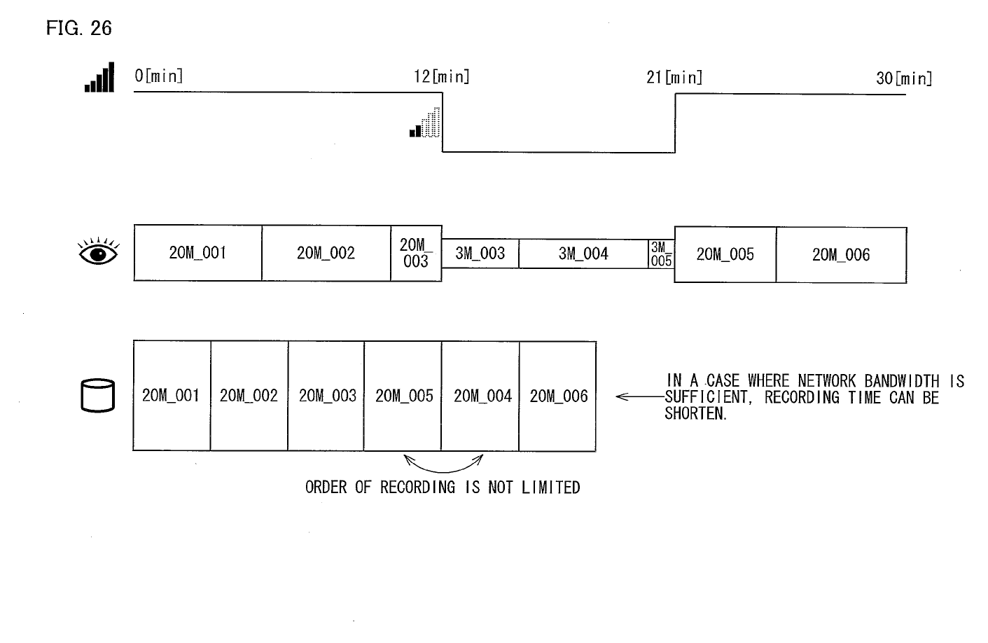

Next, with reference to FIGS. 25 and 26, a reproduction and recording process will be described in detail below which is carried out by the content reproducing device in a case where a content is associated with a reproduction control metafile as illustrated in FIG. 5. FIGS. 25 and 26 are views each illustrating, with respect to a time axis of reproduction of a content, (i) a wireless communication state between the content reproducing device and the content delivering device, (ii) content data reproduced by the content reproducing device, and (iii) the content data recorded by the tuner 1130.

Note, here, that each content has two types of data which are different in quality, i.e., high-quality data and low-quality data, as illustrated in FIG. 5. It is assumed that each reproduction time of the high-quality data and the low-quality data is 30 minutes and each of the high-quality data and the low-quality data is time-divided into six segments. That is, a time length of each of the six segments is assumed to be five minutes.

It is also assumed that the wireless communication state (i) is good at start (0 (zero) minute) of the reproduction of the content, (ii) becomes poor 12 minutes later from the start of the reproduction, and (iii) is then improved 21 minutes later from the start of the reproduction.

As illustrated in FIG. 25, the content is reproduced as follows. Specifically, during a time period from 0 (zero) minute to 12 minutes, a content obtaining section 401 of the monitor 1131 sequentially obtains “20M_{—}001.tts”, “20M_{—}002.tts”, and “20M_{—}003.tts” from where to obtain the high-quality data. In accordance with the high-quality data thus obtained, the content is reproduced. During a time period from 12 minutes to 21 minutes, the content obtaining section 401 first switches from where to obtain the high-quality data to where to obtain the low-quality data. The content obtaining section 401 then transmits, to a VOD server (the cloud 1104 or the server A 1103), positional information indicative of a position ahead, by 2 minutes, of the beginning of the third segment (indicative of 12 minutes or a byte), and obtains the low-quality data from the middle of a low-quality third segment. In accordance with the low-quality data thus obtained, the content is reproduced. During a time period From 21 minutes to 30 minutes, the content obtaining section 401 switches from where to obtain the low-quality data to where to obtain the high-quality data. The content obtaining section 401 then transmits, to the VOD server, positional information indicative of a position ahead, by 1 (one) minute, of the beginning of the fifth segment (indicative of 21 minutes or a byte), and obtains the high-quality data from the middle of a high-quality fifth segment. In accordance with the high-quality data thus obtained, the content is reproduced.

The tuner 1130 is connected to the cloud 1104 and the server A 1103 by wire. This allows the tuner 1130 not to be affected by the wireless communication state. Therefore, recording of the content is carried out as follows. During the time period from 0 (zero) minute to 30 minutes, a content obtaining section 202 of the tuner 1130 obtains a high-quality first segment through a high-quality sixth segment in order, and a recording performing section 203 records the high-quality first segment through the high-quality sixth segment in order.

According to an example illustrated in FIG. 26, a case is illustrated where segments are recorded in any order regardless of order of reproduction. Further, according to the example illustrated in FIG. 26, a speed of recording of a content is faster than that of reproduction of the content. Specifically, the content obtaining section 202 of the tuner 1130 obtains a high-quality first segment, a high-quality second segment, a high-quality third segment, a high-quality fifth segment, a high-quality fourth segment, and a high-quality sixth segment in this order. The recording performing section 203 records those segments in the order in which the content obtaining section 202 has obtained the segments.

In FIG. 26, the segments are recorded in the order different from the order of reproduction. However, it is possible to correctly reproduce the segments by (i) storing the segments as individual files and (ii) reading out the segments in the order of reproduction in accordance with a reproduction control metafile when reproducing the segments. Alternatively, after storing the segments as individual files, the recording performing section 203 can arrange the segments in the order of reproduction in accordance with the reproduction metafile and then again store the segments as a single file.

### Solution to Problem

In order to attain the above object, a content data recording device in accordance with the present invention is a content data recording device which records content data externally obtained, including: a first obtaining means for (i) obtaining content data used to reproduce a content by streaming and (ii) switching, depending on a communication state, between obtainment of high-quality content data and obtainment of low-quality content data; a second obtaining means for obtaining part of the high-quality content data which part has not been obtained by the first obtaining means, after the communication state is recovered; and a recording means for recording (i) the high-quality content data obtained by the first obtaining means and (ii) the part of the high-quality content data obtained by the second obtaining means.

Further, in order to attain the above object, a method of recording content data in accordance with the present invention is a method of recording content data externally obtained, including the steps of: (a) obtaining content data used to reproduce a content by streaming, and switching, depending on a communication state, between obtainment of high-quality content data and obtainment of low-quality content data; (b) obtaining part of the high-quality content data which part has not been obtained in the step (a), after the communication state is recovered; and (c) recording (i) the high-quality content data obtained in the step (a) and (ii) the part of the high-quality content data obtained in the step (b).

According to the above configuration, the recording means records (i) the high-quality content data, used to reproduce the content by streaming, which the first obtaining means has obtained as a result of switching between the obtainment of the high-quality content data and the obtainment of the low-quality content data depending on the communication state and (ii) the part of the high-quality content data which part the first obtaining means has not obtained because the first obtaining means has obtained the low-quality content data and which part the second obtaining means has obtained after the communication state is recovered. Therefore, it is possible to record all of the content data with the use of the high-quality content data while reproducing the content by streaming.

Further, the content data recording device in accordance with the present invention is preferably arranged such that the high-quality content data is time-divided into a plurality of segments; and the second obtaining means obtains whole of part of the high-quality content data which part corresponds to a segment including a time period during which the first obtaining means has not obtained the high-quality content data, after a communication state is recovered.

Here, it is possible that high-quality content data, recorded by the recording means right before the first obtaining means switches where to obtain the content data, contains an error (for example, an uncorrectable error). Therefore, it is preferable to destroy the high-quality content data containing the error.

According to the above configuration, the second obtaining means obtains, on a segment basis, the part of the high-quality content data which part the first obtaining means has not obtained, and the recording means records the part of the high-quality data. Further, since part of the high-quality data which part may contain an error is destroyed on the segment basis, it is possible to record the high-quality content data containing no error and possible to easily records, in combination, (i) the high-quality data which is used to reproduce the content by streaming and (ii) the part of the high-quality data which part the first obtaining means has not obtained.

Further, the content data recording device in accordance with the present invention is preferably arranged such that the obtainment of the high-quality content data by the first obtaining means is carried out simultaneously or simultaneously in part with the obtainment of the part of the high-quality content data by the second obtaining means which part has not been obtained by the first obtaining means.

According to the above configuration, the part of the high-quality content data which part the first obtaining means has not obtained is recorded while the high-quality content data, which is used to reproduce the content by streaming and which has been obtained by the first obtaining means, is being recorded. Therefore, it is possible to record all of the content with the use of the high-quality data in short time while reproducing the content by streaming.

Note that the content data recording device can be realized by a computer. In this case, the scope of the present invention also encompasses (i) a control program for causing a computer to function as each means of the content data recording device so that the content data recording device is realized by the computer and (ii) a computer readable recording medium in which the control program is recorded.

[Supplementary Note]

The present invention is not limited to the description of the embodiments, but may be altered by a skilled person in the art within the scope of the claims. An embodiment derived from a proper combination of technical means disclosed in different embodiments is also encompassed in the technical scope of the present invention.

Finally, each block of the content delivering device (tuner 1130) and the content reproducing device (monitor 1131), especially, the front end 110, the demultiplexer 120, the video and audio transcoding section 130, the video and audio decoding section 131, the remultiplexer 140, the HDMI encoding section 141, the program information decoding section 150, the program guide data generating section 160, the control section 200, the demultiplexer 310, the video and audio decoding section 320, the image synthesizing section 340, the program information decoding section 360, the program guide data generating section 370, the control section 400, and the HDMI decoding section 450 can be implemented by hardware logic or can be alternatively implemented as below by software with the use of a CPU.

That is, each of the content delivering device and the content reproducing device includes: a CPU (Central Processing Unit) which executes instructions of a control program that carries out the foregoing functions; and a storage device (recording medium) such as a ROM (Read Only Memory) which stores the program, a RAM (Random Access Memory) in which the program is loaded, and a memory which stores the program and various sets of data. The object of the present invention can be attained by (i) supplying, to each of the content delivering device and the content reproducing device, the recoding medium in which program codes (an executable program, an intermediate code program, and a source program) of a program for controlling the content delivering device and the content reproducing device, each of which is implemented by software that executes the foregoing functions, are computer-readably recorded and (ii) causing a computer (or a CPU or an MPU) of the each of content delivering device and the content reproducing device to read and execute the program codes recorded in the recording medium.

Examples of the recording medium includes: (i) tapes such as a magnetic tape and a cassette tape; (ii) disks including magnetic disks, such as a Floppy (Registered Trademark) disk and a hard disk, and optical disks, such as a CD-ROM, an MO, an MD, a DVD, and a CD-R; (iii) cards such as an IC card (including a memory card) and an optical card; and (iv) semiconductor memories such as a mask ROM, EPROM, EEPROM, and a flash ROM.

Each of the content delivering device and content reproducing device can be connected to a communication network so that the program codes are supplied to the content delivering device and content reproducing device via the communication network. This communication network is not limited to any particular one, provided that the program codes can be transmitted. Examples of the communication network include the Internet, an intranet, an extranet, a LAN, an ISDN, a VAN, a CATV communications network, a virtual private network, a telephone network, a mobile telecommunications network, and a satellite communication network. Further, a transmission medium by which the communication network is constituted is not limited to any particular one, provided that the program codes can be transmitted. Examples of the transmission medium include: wired transmission media such as IEEE1394, a USB, a power-line carrier, a cable TV circuit, a telephone line, and an ADSL (Asymmetric Digital Subscriber Line); and wireless transmission media such as infrared communication systems such as IrDA and a remote control, Bluetooth (Registered Trademark), IEEE802.11 wireless communication system, HDR, a mobile phone network, a satellite circuit, and a digital terrestrial network. Note that the present invention can also be implemented by the program in the form of a computer data signal embedded in a carrier wave which is embodied by electronic transmission.

### INDUSTRIAL APPLICABILITY

The present invention can be used for (i) a content reproducing device which reproduces a content and (ii) a content delivering device which delivers a content.

### REFERENCE SIGNS LIST

1100 Content delivering system
1103 Server A (content delivering device)
1104 Cloud (content delivering device)
1130 Tuner
1131 Monitor (content data recording device, content reproducing device)
401 Content obtaining section (first obtaining means, second obtaining means)
404 Recording performing section (recording means)

1. A content data recording device which records content data externally obtained, comprising:
means for obtaining information indicative of where to obtain content data;
a first obtaining means for (i) obtaining, in accordance with the information thus obtained, the content data used to reproduce a content by streaming and (ii) switching, depending on a communication state, between obtainment of high-quality part of the content data and obtainment of low-quality part of the content data;
a second obtaining means for obtaining, in accordance with the information thus obtained, part of the high-quality part which part has not been obtained by the first obtaining means, after the communication state is recovered; and
a recording means for recording (i) the high-quality part obtained by the first obtaining means and (ii) the part of the high-quality part obtained by the second obtaining means.

2. The content data recording device as set forth in claim 1, wherein:
the content data is time-divided into a plurality of segments; and
the second obtaining means obtains, on a segment basis, the part of the high-quality part which part has not been obtained by the first obtaining means, after the communication state is recovered.

3. The content data recording device as set forth in claim 1, wherein the obtainment of the high-quality part by the first obtaining means is carried out simultaneously or simultaneously in part with the obtainment of the part of the high-quality part by the second obtaining means which part has not been obtained by the first obtaining means.

4. A method of recording content data externally obtained, comprising the steps of:
(a) obtaining information indicative of where to obtain content data;
(b) obtaining, in accordance with the information thus obtained, the content data used to reproduce a content by streaming, and switching, depending on a communication state, between obtainment of high-quality part of the content data and obtainment of low-quality part of the content data;
(c) obtaining, in accordance with the information thus obtained, part of the high-quality part which part has not been obtained in the step (b), after the communication state is recovered; and
(d) recording (i) the high-quality part obtained in the step (b) and (ii) the part of the high-quality part obtained in the step (c).

5. (canceled)

6. A non-transitory computer-readable recording medium in which a control program is recorded,
the control program causing a computer to function as each means of a content data recording device which records content data externally obtained,
the content data recording device including:
means for obtaining information indicative of where to obtain content data;
a first obtaining means for (i) obtaining, in accordance with the information thus obtained, the content data used to reproduce a content by streaming and (ii) switching, depending on a communication state, between obtainment of high-quality part of the content data and obtainment of low-quality part of the content data;
a second obtaining means for obtaining, in accordance with the information thus obtained, part of the high-quality part which part has not been obtained by the first obtaining means, after the communication state is recovered; and
a recording means for recording (i) the high-quality part obtained by the first obtaining means and (ii) the part of the high-quality part obtained by the second obtaining means.

7. A content delivering system comprising:
a content data recording device recited in claim 1;
a content delivering device for transmitting content data to the content data recording device.
